(19) United States
(12) Patent Application Publication
(10) Pub. No.: US 2026/0113459 A1
(43) Pub. Date: Apr. 23, 2026

(54) IMAGE DECODING METHOD, IMAGE DECODING DEVICE, IMAGE ENCODING METHOD, AND IMAGE ENCODING DEVICE USING BOUNDARY FILTERING

(71) Applicant: SAMSUNG ELECTRONICS CO., LTD., Suwon-si (KR)

(72) Inventors: Jeeyoon PARK, Suwon-si (KR); Minsoo PARK, Suwon-si (KR); Kwangpyo CHOI, Suwon-si (KR)

(73) Assignee: SAMSUNG ELECTRONICS CO., LTD., Suwon-si (KR)

(21) Appl. No.: 19/423,500

(22) Filed: Dec. 17, 2025

Related U.S. Application Data
(63) Continuation of application No. PCT/KR2024/008205, filed on Jun. 14, 2024.

(30) Foreign Application Priority Data
Jul. 5, 2023 (KR) 10-2023-0087410
Dec. 21, 2023 (KR) 10-2023-0188790

(51) Int. Cl. H04N 19/14; H04N 19/117; H04N 19/176; H04N 19/86

(52) U.S. Cl. CPC H04N 19/14; H04N 19/117; H04N 19/176; H04N 19/86

(57) ABSTRACT

An image decoding method includes performing boundary filtering on a template region located around a current block; identifying a first search template region and a second search template region which correspond to the template region in a search region in a current picture including the current block; performing boundary filtering on the first search template region and the second search template region; determining a search template region that is most similar to a filtered template region among the filtered first search template region and the filtered second search template region; determining a matching block corresponding to the current block based on the search template region; performing boundary filtering on the matching block; and predicting the current block based on the filtered matching block.

### CROSS-REFERENCE TO RELATED APPLICATIONS

This application is a continuation application of International Application No. PCT/KR2024/008205, filed on Jun. 14, 2024, which claims priority to Korean Patent Application No. 10-2023-0188790, filed on Dec. 21, 2023, in the Korean Intellectual Property Office, and Korean Provisional Patent Application No. 10-2023-0087410, filed on Jul. 5, 2023, in the Korean Intellectual Property Office, the disclosures of which are incorporated by reference herein in their entireties.

### 1. FIELD

The present disclosure relates to an image decoding method, an image decoding apparatus, an image encoding method, and an image encoding apparatus, and more particularly, to image decoding and encoding that perform boundary filtering on reconstructed regions used for intra prediction.

### BACKGROUND

### 2. Description of Related Art

A codec, such as, H.264 Advanced Video Coding (H.264 AVC), High Efficiency Video Coding (HEVC), and Versatile Video Coding (VVC), may split an image into blocks, and each block may be prediction encoded and prediction decoded through inter prediction or intra prediction.

The intra prediction corresponds to a method of compressing an image by removing spatial redundancy in the image, and the inter prediction corresponds to a method of compressing an image by removing temporal redundancy between images.

For intra prediction, various prediction modes such as a DC mode, a planar mode, and a directional mode are used, and when the directional mode is used, the directional mode gradually becomes finer.

As the directional mode becomes finer and the prediction mode is added, accurate prediction values are obtained, but there is a limit to adding the prediction mode with respect to the rate-distortion performance because information to be transmitted increases. That is, the amount of information related to an intra prediction mode to be transmitted is greater than the gain obtained by reducing errors of predicted values, and thus, compression efficiency is reduced. In order to overcome this limitation, intra prediction methods of directly deriving prediction mode information about a decoding side while reducing the overhead of information related to the intra prediction mode are increasing

In particular, as regions of reconstructed samples accessible during intra prediction increases, technologies for generating predictors on their own without receiving information related to the intra prediction mode on the decoding side have been newly proposed. These technologies use previously reconstructed regions and have difficulty generating predictors due to the discontinuity occurring at edges of blocks in the reconstructed regions. There is demand for a method of solving these problems.

### SUMMARY

According to an aspect of the present disclosure, an image decoding method includes performing boundary filtering on a template region located around a current block; identifying a first search template region and a second search template region which correspond to the template region in a search region in a current picture including the current block; performing boundary filtering on the first search template region and the second search template region; determining a search template region that is most similar to a filtered template region among the filtered first search template region and the filtered second search template region; determining a matching block corresponding to the current block based on the search template region; performing boundary filtering on the matching block; and predicting the current block based on the filtered matching block.

The template region may be an L-shaped region may include at least one left reference sample located on the left of the current block, at least one top left reference sample located on the left of the current block, and at least one top reference sample located on the top of the current block.

The search region may include a reconstructed region in the current picture.

An intensity of the boundary filtering may be determined based on a size of the current block.

An intensity of the boundary filtering may be determined based on intra prediction modes of blocks in the search region.

An intensity of the boundary filtering may be determined based on a number of blocks in the search region.

The boundary filtering may be performed based on a flag for indicating whether boundary filtering is performed, the flag is obtained from a bitstream.

A type of the boundary filtering may be determined based on an index indicating a filter type obtained from the bitstream.

An intensity of the boundary filtering on the template region, an intensity of the boundary filtering on the first search template region, an intensity of the boundary filtering on the second search template region, and an intensity of the boundary filtering on the matching block may be independently determined.

A filtering intensity of deblocking filtering on the current picture may be determined based on the boundary filtering being performed.

According to an aspect of the present disclosure, an image encoding method includes performing boundary filtering on a template region located around a current block; identifying a first search template region and a second search template region which correspond to the template region in a search region in a current picture including the current block; performing boundary filtering on the first search template region and the second search template region; determining a search template region that is most similar to the filtered template region among the filtered first search template region and the filtered second search template region; determining a matching block corresponding to the current block based on the search template region; performing boundary filtering on the matching block; and predicting the current block based on the filtered matching block.

The template region is may be L-shaped region and may include at least one left reference sample located on the left of the current block, at least one top left reference sample located on the left of the current block, and at least one top reference sample located on the top of the current block.

The search region may include an encoded region in the current picture.

An intensity of the boundary filtering may be determined based on a size of the current block.

An intensity of the boundary filtering may be determined based on intra prediction modes of blocks in the search region.

An intensity of the boundary filtering may be determined based on a number of blocks in the search region.

The boundary filtering may be performed based on a flag for indicating whether boundary filtering is performed, the flag is obtained from a bitstream.

A type of the boundary filtering may be determined based on an index indicating a filter type obtained from the bitstream.

An intensity of the boundary filtering on the template region, an intensity of the boundary filtering on the first search template region, an intensity of the boundary filtering on the second search template region, and an intensity of the boundary filtering on the matching block may be independently determined.

A filtering intensity of deblocking filtering on the current picture may be determined based on the boundary filtering being performed . . .

### BRIEF DESCRIPTION OF THE DRAWINGS

The above and other aspects, features, and advantages of certain embodiments of the present disclosure will be more apparent from the following description taken in conjunction with the accompanying drawings, in which

FIG. 1 illustrates a schematic block diagram of an image decoding apparatus according to an embodiment of the present disclosure;

FIG. 2 is a flowchart of an image decoding method according to an embodiment of the present disclosure;

FIG. 3 illustrates a process, performed by an image decoding apparatus, of determining at least one coding unit by splitting a current coding unit, according to an embodiment of the present disclosure;

FIG. 4 illustrates a process, performed by an image decoding apparatus, of determining at least one coding unit by splitting a non-square coding unit, according to an embodiment of the present disclosure;

FIG. 5 illustrates a process, performed by an image decoding apparatus, of splitting a coding unit based on at least one of block shape information or split shape mode information, according to an embodiment of the present disclosure;

FIG. 6 illustrates a method, performed by an image decoding apparatus, of determining a certain coding unit from among an odd number of coding units, according to an embodiment of the present disclosure;

FIG. 7 illustrates an order of processing a plurality of coding units when an image decoding apparatus determines the plurality of coding units by splitting a current coding unit, according to an embodiment of the present disclosure;

FIG. 8 illustrates a process, performed by an image decoding apparatus, of determining that a current coding unit is to be split into an odd number of coding units, when the coding units are not processable in a certain order, according to an embodiment of the present disclosure;

FIG. 9 illustrates a process, performed by an image decoding apparatus, of determining at least one coding unit by splitting a first coding unit, according to an embodiment of the present disclosure;

FIG. 10 illustrates that a shape into which a second coding unit is splittable is restricted when the second coding unit having a non-square shape, which is determined when an image decoding apparatus splits a first coding unit, satisfies a certain condition, according to an embodiment of the present disclosure;

FIG. 11 illustrates a process, performed by an image decoding apparatus, of splitting a square coding unit when split shape mode information is unable to indicate that the square coding unit is split into four square coding units, according to an embodiment of the present disclosure;

FIG. 12 illustrates that a processing order between a plurality of coding units may be changed depending on a process of splitting a coding unit, according to an embodiment of the present disclosure;

FIG. 13 illustrates a process of determining a depth of a coding unit as a shape and size of the coding unit change, when the coding unit is recursively split such that a plurality of coding units are determined, according to an embodiment of the present disclosure;

FIG. 14 illustrates depths that are determinable based on shapes and sizes of coding units, and part indexes (PIDs) that are for distinguishing the coding units, according to an embodiment of the present disclosure;

FIG. 15 illustrates that a plurality of coding units are determined based on a plurality of certain data units included in a picture, according to an embodiment of the present disclosure;

FIG. 16 illustrates a processing block serving as a unit for determining a determination order of reference coding units included in a picture, according to an embodiment of the present disclosure;

FIG. 17 is a diagram for describing an intra template matching prediction (TMP) method according to an embodiment of the present disclosure;

FIG. 18 is a diagram for describing a template-based intra mode derivation (TIMD) method according to an embodiment of the present disclosure;

FIG. 19 is a diagram for describing a method of using a template-based multiple reference line (TMRL) according to an embodiment of the present disclosure;

FIG. 20 is a diagram for describing a decoder-side intra mode derivation (DIMD) method according to an embodiment of the present disclosure;

FIG. 21 is a diagram for describing a method of applying boundary filtering according to an embodiment of the present disclosure;

FIG. 22 is a diagram for describing a method of applying boundary filtering according to an embodiment of the present disclosure;

FIG. 23 is a diagram for describing a decoder-side intra mode derivation (DIMD) method according to an embodiment of the present disclosure;

FIG. 24 illustrates an example of samples located at a boundary between two blocks to which deblocking filtering is applied;

FIG. 25 is a diagram for describing a method of determining a type of a filter for deblocking filtering;

FIG. 26 is a diagram for describing deblocking filtering according to an embodiment of the present disclosure;

FIG. 27 is a diagram for describing an image decoding method according to an embodiment of the present disclosure;

FIG. 28 is a block diagram illustrating an image decoding apparatus according to an embodiment of the present disclosure;

FIG. 29 is a diagram for describing an image encoding method according to an embodiment of the present disclosure; and

FIG. 30 is a block diagram illustrating an image encoding apparatus according to an embodiment of the present disclosure.

### DETAILED DESCRIPTION

Throughout the present disclosure, the expression “at least one of a, b or c” indicates only a, only b, only c, both a and b, both a and c, both b and c, or all of a, b, and c.

Advantages and features of embodiments and methods of accomplishing the same may be understood more readily by reference to the embodiments and the accompanying drawings. In this regard, the present disclosure may have different forms and should not be construed as being limited to the embodiments set forth herein. Rather, these embodiments are provided so that this present disclosure will be thorough and complete and will fully convey the concept of the present disclosure to one of ordinary skill in the art.

The terms used in the specification will be briefly defined, and the embodiments will be described in detail.

All terms including descriptive or technical terms which are used in the specification should be construed as having meanings that are obvious to one of ordinary skill in the art. However, the terms may have different meanings according to the intention of one of ordinary skill in the art, precedent cases, or the appearance of new technologies. In addition, some terms may be arbitrarily selected by the applicant, and in this case, the meaning of the selected terms will be described in detail in the detailed description of the present disclosure. Therefore, the terms used in the present disclosure should not be interpreted based on only their names but have to be defined based on the meaning of the terms together with the descriptions throughout the specification.

In the following specification, the singular forms include plural forms unless the context clearly indicates otherwise.

Throughout the specification, when a part “includes” or “comprises” an element, unless there is a particular description contrary thereto, the part may further include other elements, not excluding the other elements.

In addition, numerals (e.g., “first”, “second”, etc.) in the description of the specification are used only to distinguish one element from another element.

In addition, terms such as “unit” indicate a software or hardware element and the “unit” performs certain functions. However, the “unit” is not limited to software or hardware. The “unit” may be formed so as to be in an addressable storage medium, or may be formed so as to operate one or more processors. Thus, for example, the term “unit” may refer to elements such as software elements, object-oriented software elements, class elements, and task elements, and may include processes, functions, attributes, procedures, subroutines, segments of program code, drivers, firmware, micro codes, circuits, data, a database, data structures, tables, arrays, or variables. A function provided by the elements and “units” may be associated with a smaller number of elements and “units”, or may be divided into additional elements and “units”.

According to an embodiment of the present disclosure, the “unit” may include a processor and memory. The term “processor” should be interpreted broadly to include a general purpose processor, a central processing unit (CPU), a microprocessor, a digital signal processor (DSP), a controller, a microcontroller, a state machine, etc. In some environments, the “processor” may refer to an application specific semiconductor (ASIC), a programmable logic device (PLD), a field programmable gate array (FPGA), etc. The term “processor” may refer to a combination of processing devices such as, for example, a combination of a DSP and a microprocessor, a combination of a plurality of microprocessors, a combination of one or more microprocessors in conjunction with a DSP core, or a combination of any other such configurations.

The processor may include various circuits and/or a plurality of processors. For example, the term “processor” used herein, including the claims, may include various types of processing circuitry including at least one processor. One or more processors in the at least one processor may be configured to individually and/or collectively perform various functions described here in a distributed manner. As used herein, “processor”, “at least one processor”, and “one or more processors” may be configured to perform various functions. However, the recited terms cover a situation in which one processor performs some of the functions and other processor(s) performs the other functions, and a situation in which one processor may perform all of the functions. In addition, at least one processor may include a combination of processors configured to perform a variety of the disclosed functions in a distributed manner. The at least one processor may execute program instructions to achieve or perform various functions.

The term “memory” should be interpreted broadly to include any electronic component capable of storing electronic information. The term “memory” may refer to various types of processor-readable media such as random access memory (RAM), a read-only memory (ROM), a non-volatile random access memory (NVRAM), a programmable read-only memory (PROM), an erase-programmable read-only memory (EPROM), an electrically erasable PROM (EEPROM), a flash memory, a magnetic or optical data storage device, registers, etc. When the processor may read information from memory and/or write information to the memory, the memory is said to be in an electronic communication state with the processor. The memory integrated in the processor is in an electronic communication state with the processor.

Hereinafter, an “image” may be a static image such as a still image of a video or may be a dynamic image such as a moving image, that is, the video itself.

Hereinafter, a “sample” denotes data assigned to a sampling position of an image, i.e., data to be processed. For example, pixel values of an image in a spatial domain and transform coefficients on a transform domain may be samples. A unit including at least one such sample may be defined as a block.

In addition, in the specification, a “current block” may indicate a block of a largest coding unit, coding unit, prediction unit, or transform unit of a current image to be encoded or decoded, or a subblock of the block.

Hereinafter, an embodiment will be described in detail with reference to the accompanying drawings to allow one of ordinary skill in the art to easily implement the embodiment. In addition, portions irrelevant to the description will be omitted in the drawings for a clear description of the present disclosure.

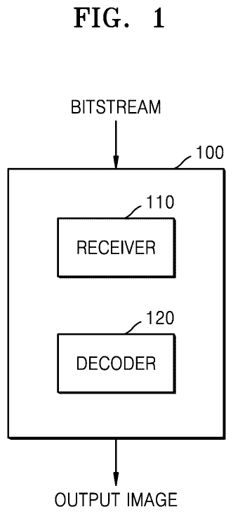

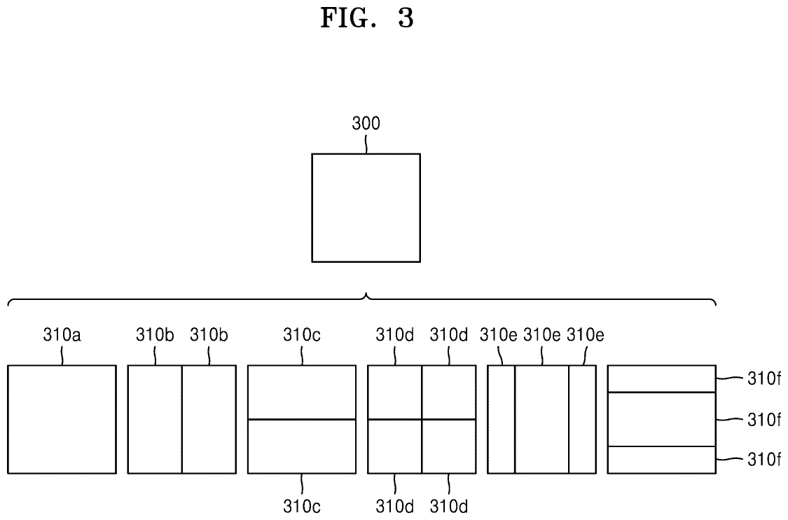

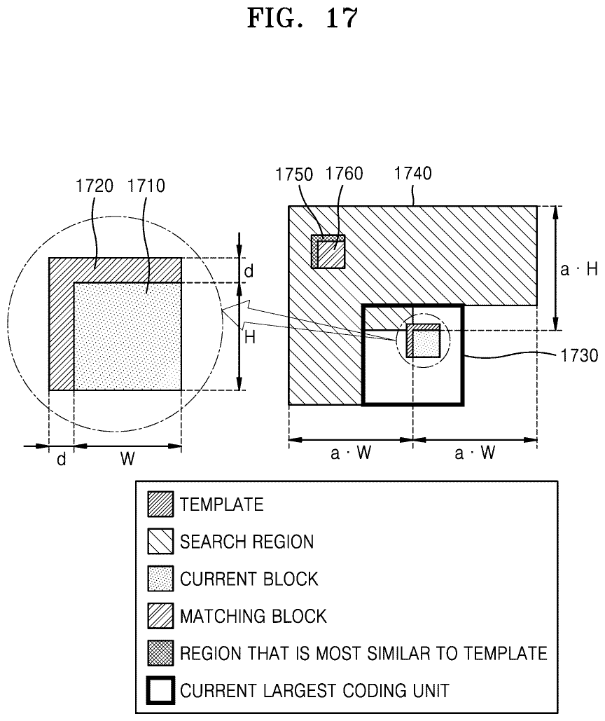

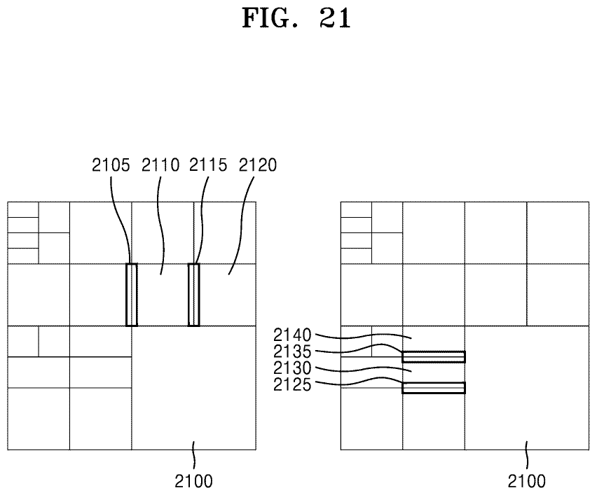

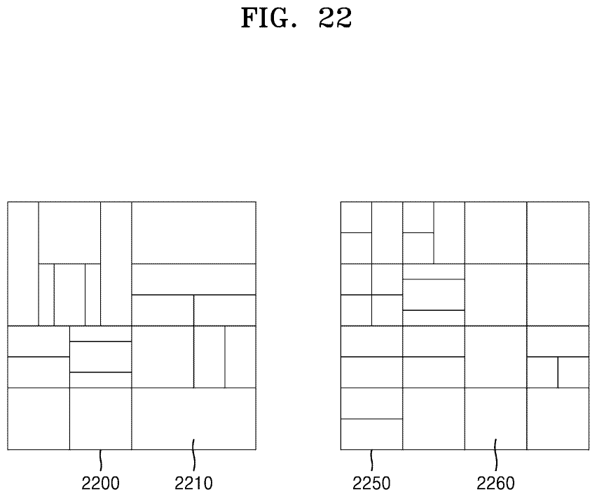

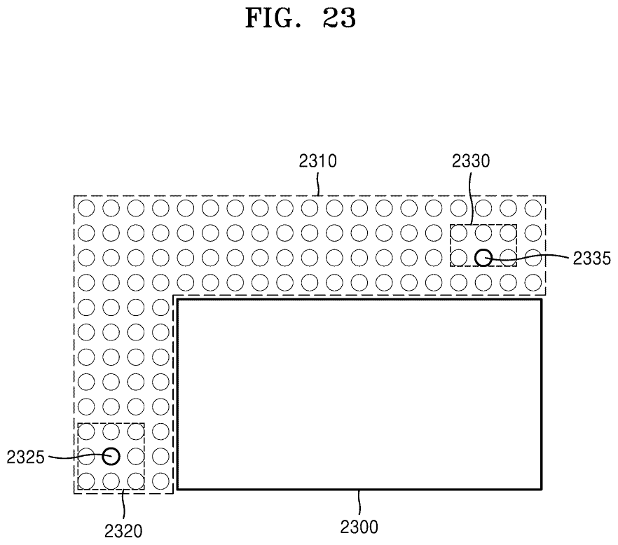

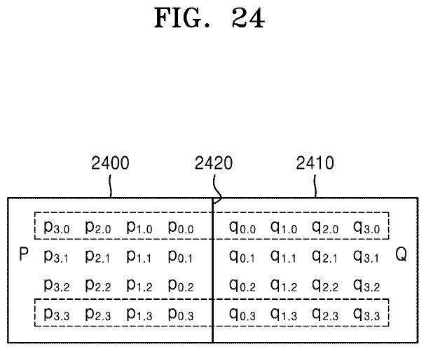

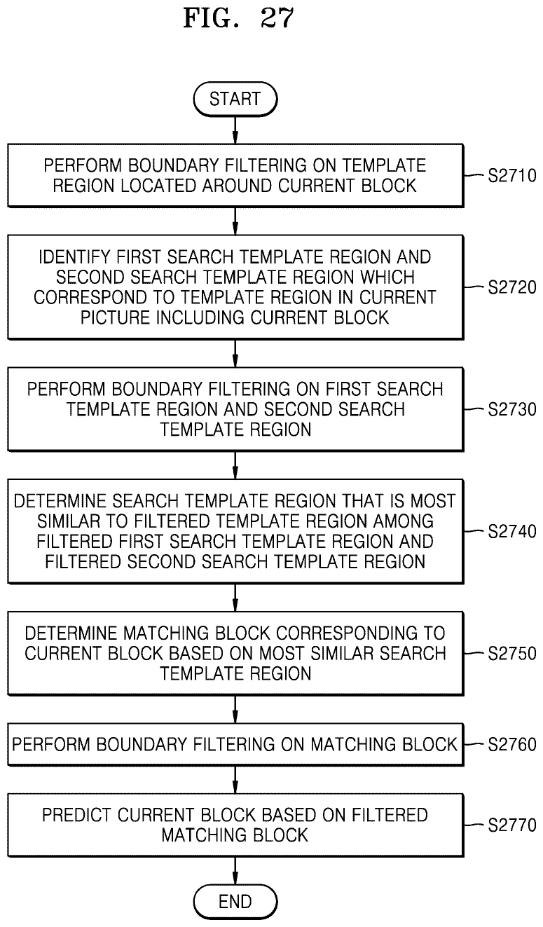

Hereinafter, with reference to FIGS. 1 to 16, an image encoding apparatus and an image decoding apparatus, and an image encoding method and an image decoding method will be described in detail according to an embodiment of the present disclosure. Referring to FIGS. 3 to 16, a method of determining a data unit of an image according to an embodiment of the present disclosure will be described, referring to FIGS. 17 to 20, template-based intra prediction methods and template-based intra prediction methods with additional boundary filtering according to an embodiment of the present disclosure will be described, referring to FIGS. 21 and 22, boundary filtering methods according to an embodiment of the present disclosure will be described, referring to FIG. 23, a method of applying a strong filter to a template region of decoder-side intra mode derivation (DIMD), highlighting an edge component, and then obtaining a histogram value by partially obtaining a gradient will be described, referring to FIGS. 24 to 26, a general deblocking filtering method and a deblocking filtering method when filtering is performed on a reconstructed region or a template region in intra prediction will be described, and referring to FIGS. 27 to 30, an image encoding apparatus and an image decoding apparatus, and an image encoding method and an image decoding method using intra template matching prediction (TMP) to which boundary filtering is applied according to an embodiment of the present disclosure will be described.

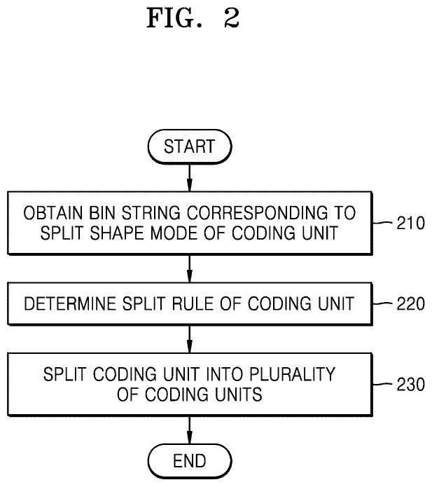

Hereinafter, with reference to FIGS. 1 and 2, according to an embodiment of the present disclosure, a method and apparatus for adaptively selecting a context model, based on various shapes of coding units, will now be described in detail.

FIG. 1 illustrates a schematic block diagram of an image decoding apparatus according to an embodiment of the present disclosure.

An image decoding apparatus 100 may include a receiver 110 and a decoder 120. The receiver 110 and the decoder 120 may include at least one processor. In addition, the receiver 110 and the decoder 120 may include memory storing instructions to be performed by the at least one processor.

The receiver 110 may receive a bitstream. The bitstream includes information about an image encoded by an image encoding apparatus 2200 to be described below. In addition, the bitstream may be transmitted from the image encoding apparatus 2200. The image encoding apparatus 2200 and the image decoding apparatus 100 may be connected by wire or wirelessly, and the receiver 110 may receive the bitstream by wire or wirelessly. The receiver 110 may receive the bitstream from a storage medium such as an optical medium, a hard disk, etc. The decoder 120 may reconstruct an image based on information obtained from the received bitstream. The decoder 120 may obtain, from the bitstream, a syntax element for reconstructing the image. The decoder 120 may reconstruct the image based on the syntax element.

Operations of the image decoding apparatus 100 will be described in detail with reference to FIG. 2.

FIG. 2 is a flowchart of an image decoding method according to an embodiment of the present disclosure.

According to an embodiment of the present disclosure, the receiver 110 receives a bitstream.

The image decoding apparatus 100 obtains, from the bitstream, a bin string corresponding to a split shape mode of a coding unit (operation 210). The image decoding apparatus 100 determines a split rule of the coding unit (operation 220). In addition, the image decoding apparatus 100 splits the coding unit into a plurality of coding units, based on at least one of the bin string corresponding to the split shape mode or the split rule (operation 230). The image decoding apparatus 100 may determine an allowable first range of a size of the coding unit, according to a ratio of height to width of the coding unit, so as to determine the split rule. The image decoding apparatus 100 may determine an allowable second range of the size of the coding unit, according to the split shape mode of the coding unit, so as to determine the split rule.

Hereinafter, splitting of a coding unit will be described in detail according to an embodiment of the present disclosure.

First, one picture may be split into one or more slices or one or more tiles. One slice or one tile may be a sequence of one or more largest coding units (coding tree units (CTUs)). A largest coding block (coding tree block (CTB)) is conceptually compared to a largest coding unit (CTU).

The largest coding block (CTB) indicates an N×N block including N×N samples (N is an integer). Each color component may be split into one or more largest coding blocks.

A largest coding unit (CTU) of a case where a picture includes three sample arrays (sample arrays for Y, Cr, and Cb components) is a unit including a largest coding block of a luma sample, two corresponding largest coding blocks of chroma samples, and syntax structures used to encode the luma sample and the chroma samples. A largest coding unit of a case where a picture is a monochrome picture is a unit including a largest coding block of a monochrome sample and syntax structures used to encode monochrome samples. A largest coding unit of a case where a picture is a picture encoded in color planes separated according to color components is a unit including syntax structures used to encode the picture and samples of the picture.

One largest coding block (CTB) may be split into M×N coding blocks including M×N samples (M and N are integers).

A coding unit (CU) of a case where a picture has sample arrays for Y, Cr, and Cb components is a unit including a coding block of a luma sample, two corresponding coding blocks of chroma samples, and syntax structures used to encode the luma sample and the chroma samples. A coding unit of a case where a picture is a monochrome picture is a unit including a coding block of a monochrome sample and syntax structures used to encode the monochrome samples. A coding unit of a case where a picture is a picture encoded in color planes separated according to color components is a unit including syntax structures used to encode the picture and samples of the picture.

As described above, a largest coding block and a largest coding unit are conceptually distinguished from each other, and a coding block and a coding unit are conceptually distinguished from each other. That is, a (largest) coding unit refers to a data structure including a (largest) coding block including a corresponding sample and a syntax structure corresponding to the (largest) coding block. However, because it is understood by one of ordinary skill in the art that a (largest) coding unit or a (largest) coding block refers to a block of a certain size including a certain number of samples, a largest coding block and a largest coding unit, or a coding block and a coding unit are mentioned in the following specification without being distinguished unless otherwise described.

An image may be split into largest coding units (CTUs). A size of each largest coding unit may be determined based on information obtained from a bitstream. A shape of each largest coding unit may be a square shape of the same size. However, the present disclosure is not limited thereto.

For example, information about a maximum size of a luma coding block may be obtained from a bitstream. For example, the maximum size of the luma coding block indicated by the information about the maximum size of the luma coding block may be one of 4×4, 8×8, 16×16, 32×32, 64×64, 128×128, and 256×256.

For example, information about a luma block size difference and a maximum size of a luma coding block that may be split into two may be obtained from a bitstream. The information about the luma block size difference may refer to a size difference between a luma largest coding unit and a largest luma coding block that may be split into two. Accordingly, when the information about the maximum size of the luma coding block that may be split into two and the information about the luma block size difference obtained from the bitstream are combined with each other, a size of the luma largest coding unit may be determined. A size of a chroma largest coding unit may be determined by using the size of the luma largest coding unit. For example, when a Y:Cb:Cr ratio is 4:2:0 according to a color format, a size of a chroma block may be half a size of a luma block, and a size of a chroma largest coding unit may be half a size of a luma largest coding unit.

According to an embodiment, because information about a maximum size of a luma coding block that is binary splittable is obtained from a bitstream, the maximum size of the luma coding block that is binary splittable may be variably determined. In contrast, a maximum size of a luma coding block that is ternary splittable may be fixed. For example, the maximum of the luma coding block that is ternary splittable in an I-picture may be 32×32, and the maximum of the luma coding block that is ternary splittable in a P-picture or a B-picture may be 64×64.

In addition, a largest coding unit may be hierarchically split into coding units based on split shape mode information obtained from a bitstream. At least one of information indicating whether to perform quad splitting, information indicating whether to perform multi-splitting, split direction information, or split type information may be obtained as the split shape mode information from the bitstream.

For example, the information indicating whether to perform quad splitting may indicate whether a current coding unit is to be quad split (QUAD_SPLIT) or not.

When the current coding unit is not quad split, the information indicating whether to perform multi-splitting may indicate whether the current coding unit is to be no longer split (NO_SPLIT) or to be binary/ternary split.

When the current coding unit is binary split or ternary split, the split direction information indicates that the current coding unit is split in one of a horizontal direction and a vertical direction.

When the current coding unit is split in the horizontal direction or the vertical direction, the split type information indicates that the current coding unit is binary split or ternary split.

A split mode of the current coding unit may be determined according to the split direction information and the split type information. A split mode when the current coding unit is binary split in the horizontal direction may be determined to be a binary horizontal split mode (SPLIT_BT_HOR), a split mode when the current coding unit is ternary split in the horizontal direction may be determined to be a ternary horizontal split mode (SPLIT_TT_HOR), a split mode when the current coding unit is binary split in the vertical direction may be determined to be a binary vertical split mode (SPLIT_BT_VER), and a split mode when the current coding unit is ternary split in the vertical direction may be determined to be a ternary vertical split mode (SPLIT_BT_VER).

The image decoding apparatus 100 may obtain, from the bitstream, one bin string of the split shape mode information. A form of the bitstream received by the image decoding apparatus 100 may include fixed length binary code, unary code, truncated unary code, pre-determined binary code, etc. The bin string is information in a binary number. The bin string may include at least one bit. The image decoding apparatus 100 may obtain the split shape mode information corresponding to the bin string, based on the split rule. The image decoding apparatus 100 may determine whether to quad-split a coding unit, whether not to split a coding unit, a split direction, and a split type, based on one bin string.

The coding unit may be smaller than or the same as the largest coding unit. For example, because a largest coding unit is a coding unit having a maximum size, the largest coding unit is one of coding units. When split shape mode information about a largest coding unit indicates that splitting is not performed, a coding unit determined in the largest coding unit has the same size as that of the largest coding unit. When split shape mode information about a largest coding unit indicates that splitting is performed, the largest coding unit may be split into coding units. In addition, when split shape mode information about a coding unit indicates that splitting is performed, the coding unit may be split into smaller coding units. However, the splitting of the image is not limited thereto, and the largest coding unit and the coding unit may not be distinguished. The splitting of the coding unit will be described in detail with reference to FIGS. 3 to 16.

In addition, one or more prediction blocks for prediction may be determined from a coding unit. The prediction block may be the same as or smaller than the coding unit. In addition, one or more transform blocks for transformation may be determined from a coding unit. The transform block may be the same as or smaller than the coding unit.

The shapes and sizes of the transform block and prediction block may not be related to each other.

In another embodiment, prediction may be performed by using a coding unit as a prediction unit. In addition, transformation may be performed by using a coding unit as a transform block.

The splitting of the coding unit will be described in detail with reference to FIGS. 3 to 16. A current block and a neighboring block of the present disclosure may indicate one of the largest coding unit, the coding unit, the prediction block, and the transform block. In addition, the current block of the current coding unit is a block that is currently being decoded or encoded or a block that is currently being split. The neighboring block may be a block reconstructed before the current block. The neighboring block may be spatially or temporally adjacent to the current block. The neighboring block may be located at one of lower left, left, top left, top, top right, right, lower right of the current block.

FIG. 3 illustrates a process, performed by an image decoding apparatus, of determining at least one coding unit by splitting a current coding unit, according to an embodiment of the present disclosure.

A block shape may include 4N×4N, 4N×2N, 2N×4N, 4N×N, N×4N, 32N×N, N×32N, 16N×N, N×16N, 8N×N, or N×8N. Here, N may be a positive integer. Block shape information is information indicating at least one of a shape, a direction, a ratio of width to height, or size of a coding unit.

The shape of the coding unit may include a square and a non-square. When the lengths of the width and height of the coding unit are the same (i.e., when the block shape of the coding unit is 4N×4N), the image decoding apparatus 100 may determine the block shape information about the coding unit to be a square. The image decoding apparatus 100 may determine the shape of the coding unit to be a non-square.

When the width and the height of the coding unit are different from each other (i.e., when the block shape of the coding unit is 4N×2N, 2N×4N, 4N×N, N×4N, 32N×N, N×32N, 16N×N, N×16N, 8N×N, or N×8N), the image decoding apparatus 100 may determine the block shape information about the coding unit to be a non-square shape. When the shape of the coding unit is non-square, the image decoding apparatus 100 may determine the ratio of width to height among the block shape information about the coding unit to be at least one of 1:2, 2:1, 1:4, 4:1, 1:8, 8:1, 1:16, 16:1, 1:32, or 32:1. In addition, the image decoding apparatus 100 may determine whether the coding unit is in a horizontal direction or a vertical direction, based on the length of the width and the length of the height of the coding unit. In addition, the image decoding apparatus 100 may determine the size of the coding unit, based on at least one of the length of the width, the length of the height, or the area of the coding unit.

According to an embodiment, the image decoding apparatus 100 may determine the shape of the coding unit by using the block shape information, and may determine a split shape of the coding unit by using the split shape mode information. That is, a splitting method of the coding unit indicated by the split shape mode information may be determined based on a block shape indicated by the block shape information used by the image decoding apparatus 100.

The image decoding apparatus 100 may obtain the split shape mode information from a bitstream. However, an embodiment is not limited thereto, and the image decoding apparatus 100 and the image encoding apparatus2200 may determine pre-agreed split shape mode information, based on the block shape information. The image decoding apparatus 100 may determine the pre-agreed split shape mode information with respect to a largest coding unit or a smallest coding unit. For example, the image decoding apparatus 100 may determine split shape mode information with respect to the largest coding unit to be a quad split. In addition, the image decoding apparatus 100 may determine split shape mode information regarding the smallest coding unit to be “no split”. In particular, the image decoding apparatus 100 may determine the size of the largest coding unit to be 256×256. The image decoding apparatus 100 may determine the pre-agreed split shape mode information to be a quad split. The quad split is a split shape mode in which the width and the height of the coding unit are both bisected. The image decoding apparatus 100 may obtain a coding unit of a 128×128 size from the largest coding unit of a 256×256 size, based on the split shape mode information. In addition, the image decoding apparatus 100 may determine the size of the smallest coding unit to be 4×4. The image decoding apparatus 100 may obtain split shape mode information indicating “no split” with respect to the smallest coding unit.

According to an embodiment, the image decoding apparatus 100 may use the block shape information indicating that the current coding unit has a square shape. For example, the image decoding apparatus 100 may determine whether not to split a square coding unit, whether to vertically split the square coding unit, whether to horizontally split the square coding unit, or whether to split the square coding unit into four coding units, based on the split shape mode information. Referring to FIG. 3, when the block shape information about a current coding unit 300 indicates a square shape, the decoder 120 may determine that a coding unit 310a having the same size as the current coding unit 300 is not split, based on the split shape mode information indicating no split, or may determine coding units 310b, 310c, 310d, 310e, 310f, etc. split based on the split shape mode information indicating a certain splitting method.

Referring to FIG. 3, according to an embodiment, the image decoding apparatus 100 may determine two coding units 310b obtained by splitting the current coding unit 300 in a vertical direction, based on the split shape mode information indicating to perform splitting in a vertical direction. The image decoding apparatus 100 may determine two coding units 310c obtained by splitting the current coding unit 300 in a horizontal direction, based on the split shape mode information indicating to perform splitting in a horizontal direction. The image decoding apparatus 100 may determine four coding units 310d obtained by splitting the current coding unit 300 in vertical and horizontal directions, based on the split shape mode information indicating to perform splitting in vertical and horizontal directions. According to an embodiment, the image decoding apparatus 100 may determine three coding units 310e obtained by splitting the current coding unit 300 in a vertical direction, based on the split shape mode information indicating to perform ternary-splitting in a vertical direction. The image decoding apparatus 100 may determine three coding units 310f obtained by splitting the current coding unit 300 in a horizontal direction, based on the split shape mode information indicating to perform ternary-splitting in a horizontal direction. However, splitting methods of the square coding unit are not limited to the above-described methods, and the split shape mode information may indicate various methods. Certain splitting methods of splitting the square coding unit will be described in detail below in various embodiments.

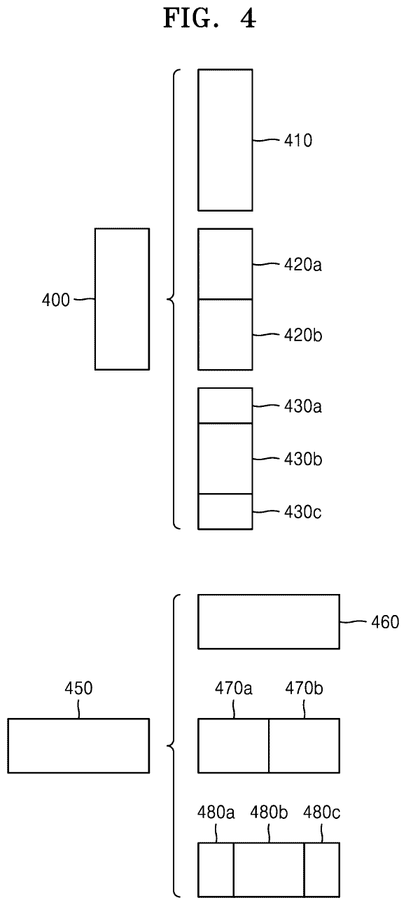

FIG. 4 illustrates a process, performed by an image decoding apparatus, of determining at least one coding unit by splitting a non-square coding unit, according to an embodiment of the present disclosure.

According to an embodiment, the image decoding apparatus 100 may use block shape information indicating that a current coding unit has a non-square shape. The image decoding apparatus 100 may determine whether not to split the non-square current coding unit or whether to split the non-square current coding unit by using a certain splitting method, based on split shape mode information. Referring to FIG. 4, when the block shape information about a current coding unit 400 or 450 indicates a non-square shape, the image decoding apparatus 100 may determine that a coding unit 410 or 460 having the same size as the current coding unit 400 or 450 is not split, based on the split shape mode information indicating no split, or may determine coding units 420a, 420b, 430a, 430b, 430c, 470a, 470b, 480a, 480b, and 480c split based on the split shape mode information indicating a certain splitting method. Certain splitting methods of splitting a non-square coding unit will be described in detail below in various embodiments.

According to an embodiment, the image decoding apparatus 100 may determine a splitting method of a coding unit by using the split shape mode information and, in this case, the split shape mode information may indicate the number of one or more coding units generated by splitting a coding unit. Referring to FIG. 4, when the split shape mode information indicates to split the current coding unit 400 or 450 into two coding units, the image decoding apparatus 100 may determine two coding units 420a and 420b, or 470a and 470b included in the current coding unit 400 or 450, by splitting the current coding unit 400 or 450 based on the split shape mode information.

According to an embodiment, when the image decoding apparatus 100 splits the non-square current coding unit 400 or 450 based on the split shape mode information, the image decoding apparatus 100 may consider the location of a long side of the non-square current coding unit 400 or 450 so as to split a current coding unit. For example, the image decoding apparatus 100 may determine a plurality of coding units by splitting the current coding unit 400 or 450 in a direction of splitting a long side of the current coding unit 400 or 450, in consideration of the shape of the current coding unit 400 or 450.

According to an embodiment, when the split shape mode information indicates to split (ternary-split) a coding unit into an odd number of blocks, the image decoding apparatus 100 may determine an odd number of coding units included in the current coding unit 400 or 450. For example, when the split shape mode information indicates to split the current coding unit 400 or 450 into three coding units, the image decoding apparatus 100 may split the current coding unit 400 or 450 into three coding units 430a, 430b, and 430c, or 480a, 480b, and 480c.

According to an embodiment, a ratio of height to width of the current coding unit 400 or 450 may be 4:1 or 1:4. When the ratio of height to width is 4:1, the block shape information may be a horizontal direction because the length of the width is longer than the length of the height. When the ratio of height to width is 1:4, the block shape information may be a vertical direction because the length of the width is shorter than the length of the height. The image decoding apparatus 100 may determine to split a current coding unit into the odd number of blocks, based on the split shape mode information. In addition, the image decoding apparatus 100 may determine a split direction of the current coding unit 400 or 450, based on the block shape information about the current coding unit 400 or 450. For example, when the current coding unit 400 is in the vertical direction, the image decoding apparatus 100 may determine the coding units 430a, 430b, and 430c by splitting the current coding unit 400 in the horizontal direction. In addition, when the current coding unit 450 is in the horizontal direction, the image decoding apparatus 100 may determine the coding units 480a, 480b, and 480c by splitting the current coding unit 450 in the vertical direction.

According to an embodiment, the image decoding apparatus 100 may determine the odd number of coding units included in the current coding unit 400 or 450, and not all the determined coding units may have the same size. For example, a certain coding unit 430b or 480b from among the determined odd number of coding units 430a, 430b, and 430c, or 480a, 480b, and 480c may have a size different from the size of the other coding units 430a and 430c, or 480a and 480c. That is, coding units that may be determined by splitting the current coding unit 400 or 450 may have multiple sizes and, in some cases, all of the odd number of coding units 430a, 430b, and 430c, or 480a, 480b, and 480c may have different sizes.

According to an embodiment, when the split shape mode information indicates to split a coding unit into the odd number of blocks, the image decoding apparatus 100 may determine the odd number of coding units included in the current coding unit 400 or 450, and further, may put a certain restriction on at least one coding unit from among the odd number of coding units generated by splitting the current coding unit 400 or 450. Referring to FIG. 4, the image decoding apparatus 100 may set a decoding process regarding the coding unit 430b or 480b to be different from that of the other coding units 430a and 430c, or 480a or 480c, the coding unit 430b or 480b being located at the center among the three coding units 430a, 430b, and 430c or 480a, 480b, and 480c generated as the current coding unit 400 or 450 is split. For example, the image decoding apparatus 100 may restrict the coding unit 430b or 480b at the center location to be no longer split or to be split only a certain number of times, unlike the other coding units 430a and 430c, or 480a and 480c.

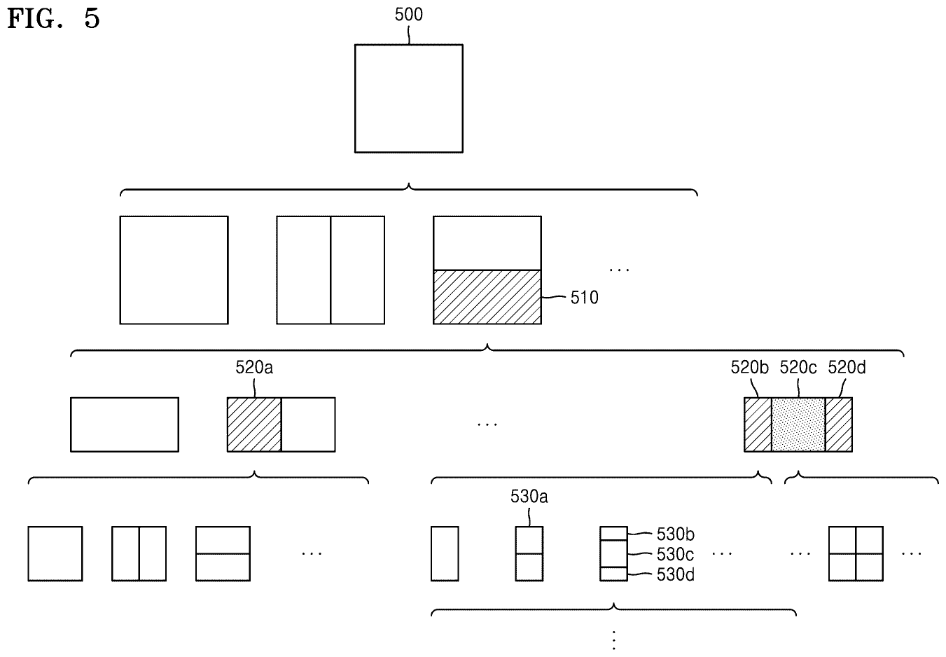

FIG. 5 illustrates a process, performed by an image decoding apparatus, of splitting a coding unit based on at least one of block shape information or split shape mode information, according to an embodiment of the present disclosure.

According to an embodiment, the image decoding apparatus 100 may determine to split or not to split a square first coding unit 500 into coding units, based on at least one of the block shape information or the split shape mode information. According to an embodiment, when the split shape mode information indicates to split the first coding unit 500 in a horizontal direction, the image decoding apparatus 100 may determine a second coding unit 510 by splitting the first coding unit 500 in a horizontal direction. A first coding unit, a second coding unit, and a third coding unit used according to an embodiment are terms used to understand a relation before and after a coding unit is split. For example, a second coding unit may be determined by splitting a first coding unit, and a third coding unit may be determined by splitting the second coding unit. Hereinafter, it will be understood that the structure of the first coding unit, the second coding unit, and the third coding unit follows the above descriptions.

According to an embodiment, the image decoding apparatus 100 may determine to split or not to split the determined second coding unit 510 into coding units, based on the split shape mode information. Referring to FIG. 5, the image decoding apparatus 100 may or may not split the non-square second coding unit 510, which is determined by splitting the first coding unit 500, into one or more third coding units 520a, 520b, 520c, and 520d based on the split shape mode information. The image decoding apparatus 100 may obtain the split shape mode information, and may obtain a plurality of various-shaped second coding units (e.g., the second coding unit 510) by splitting the first coding unit 500, based on the obtained split shape mode information, and the second coding unit 510 may be split by using a splitting method of the first coding unit 500 based on the split shape mode information. According to an embodiment, when the first coding unit 500 is split into the second coding units 510 based on the split shape mode information about the first coding unit 500, the second coding unit 510 may also be split into the third coding units (e.g., 520a, 520b, 520c, and 520d) based on the split shape mode information about the second coding unit 510. That is, a coding unit may be recursively split based on the split shape mode information about each coding unit. Therefore, a square coding unit may be determined by splitting a non-square coding unit, and a non-square coding unit may be determined by recursively splitting the square coding unit.

Referring to FIG. 5, a certain coding unit from among the odd number of third coding units 520b, 520c, and 520d determined by splitting the non-square second coding unit 510 (e.g., a coding unit at a center location or a square coding unit) may be recursively split. According to an embodiment, the square third coding unit 520b from among the odd number of third coding units 520b, 520c, and 520d may be split in a horizontal direction into a plurality of fourth coding units. A non-square fourth coding unit 530b or 530d from among a plurality of fourth coding units 530a, 530b, 530c, and 530d may be split into a plurality of coding units again. For example, the non-square fourth coding unit 530b or 530d may be split into the odd number of coding units again. A method that may be used to recursively split a coding unit will be described below in various embodiments.

According to an embodiment, the image decoding apparatus 100 may split each of the third coding units 520a, or 520b, 520c, and 520d into coding units, based on the split shape mode information. In addition, the image decoding apparatus 100 may determine not to split the second coding unit 510 based on the split shape mode information. According to an embodiment, the image decoding apparatus 100 may split the non-square second coding unit 510 into the odd number of third coding units 520b, 520c, and 520d. The image decoding apparatus 100 may put a certain restriction on a certain third coding unit from among the odd number of third coding units 520b, 520c, and 520d. For example, the image decoding apparatus 100 may restrict the third coding unit 520c at a center location from among the odd number of third coding units 520b, 520c, and 520d to be no longer split or to be split a settable number of times.

Referring to FIG. 5, the image decoding apparatus 100 may restrict the third coding unit 520c, which is at the center location from among the odd number of third coding units 520b, 520c, and 520d included in the non-square second coding unit 510, to be no longer split, to be split by using a certain splitting method (e.g., split into only four coding units or split in a manner corresponding to a splitting structure of the second coding unit 510), or to be split only a certain number of times (e.g., split only n times (where n>0)). However, the restrictions on the third coding unit 520c at the center location are not limited to the above-described embodiments, and may include various restrictions for decoding the third coding unit 520c at the center location differently from the other third coding units 520b and 520d.

According to an embodiment, the image decoding apparatus 100 may obtain the split shape mode information, which is used to split a current coding unit, from a certain location in the current coding unit.

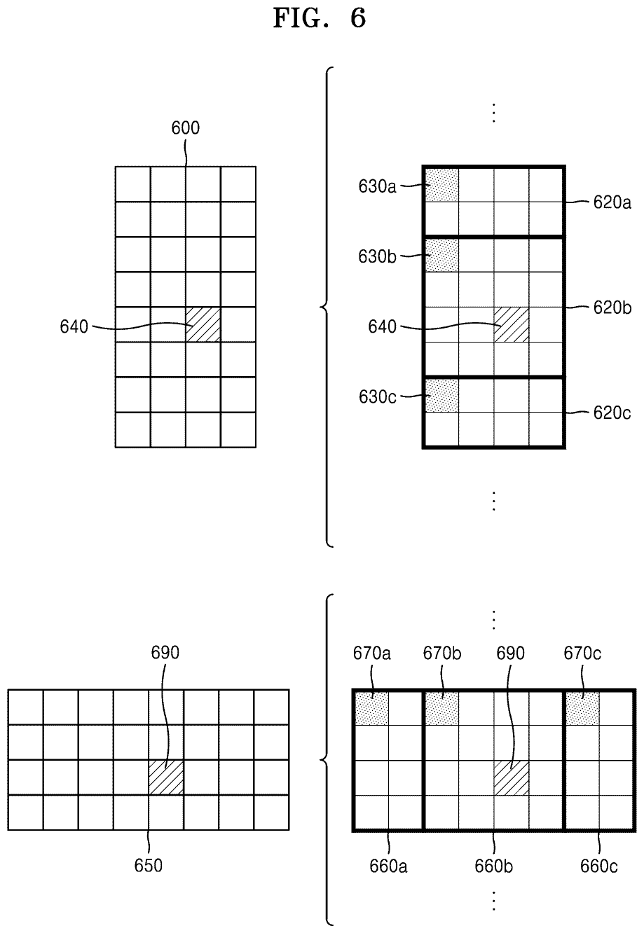

FIG. 6 illustrates a method, performed by an image decoding apparatus, of determining a certain coding unit from among an odd number of coding units, according to an embodiment of the present disclosure.

Referring to FIG. 6, split shape mode information about a current coding unit 600 or 650 may be obtained from a sample of a certain location (e.g., a sample 640 or 690 of a center location) from among a plurality of samples included in the current coding unit 600 or 650. However, the certain location in the current coding unit 600, from which at least one piece of the split shape mode information may be obtained, is not limited to the center location in FIG. 6, and may include various locations included in the current coding unit 600 (e.g., top, bottom, left, right, upper left, lower left, upper right, and lower right locations). The image decoding apparatus 100 may obtain the split shape mode information obtained from the certain location and may determine to split or not to split the current coding unit into various-shaped and various-sized coding units.

According to an embodiment, when the current coding unit is split into a certain number of coding units, the image decoding apparatus 100 may select one of the coding units. Various methods may be used to select one of a plurality of coding units, and will be described below in various embodiments.

According to an embodiment, the image decoding apparatus 100 may split the current coding unit into a plurality of coding units, and may determine a coding unit at a certain location.

According to an embodiment, image decoding apparatus 100 may use information indicating locations of the odd number of coding units so as to determine a coding unit at a center location from among the odd number of coding units. Referring to FIG. 6, the image decoding apparatus 100 may determine the odd number of coding units 620a, 620b, and 620c or the odd number of coding units 660a, 660b, and 660c by splitting the current coding unit 600 or the current coding unit 650. The image decoding apparatus 100 may determine the middle coding unit 620b or the middle coding unit 660b by using information about the locations of the odd number of coding units 620a, 620b, and 620c or the odd number of coding units 660a, 660b, and 660c. For example, the image decoding apparatus 100 may determine the coding unit 620b of the center location by determining the locations of the coding units 620a, 620b, and 620c based on information indicating locations of certain samples included in the coding units 620a, 620b, and 620c. Specifically, the image decoding apparatus 100 may determine the coding unit 620b at the center location by determining the locations of the coding units 620a, 620b, and 620c based on information indicating locations of upper left samples 630a, 630b, and 630c of the coding units 620a, 620b, and 620c.

According to an embodiment, the information indicating the locations of the upper left samples 630a, 630b, and 630c, which are included in the coding units 620a, 620b, and 620c, respectively, may include information about locations or coordinates of the coding units 620a, 620b, and 620c in a picture. According to an embodiment, the information indicating the locations of the upper left samples 630a, 630b, and 630c, which are included in the coding units 620a, 620b, and 620c, respectively, may include information indicating widths or heights of the coding units 620a, 620b, and 620c included in the current coding unit 600, and the widths or heights may correspond to information indicating differences between the coordinates of the coding units 620a, 620b, and 620c in the picture. That is, the image decoding apparatus 100 may determine the coding unit 620b at the center location by directly using the information about the locations or coordinates of the coding units 620a, 620b, and 620c in the picture, or by using the information about the widths or heights of the coding units, which correspond to the difference values between the coordinates.

According to an embodiment, information indicating the location of the upper left sample 630a of the upper coding unit 620a may include coordinates (xa, ya), information indicating the location of the upper left sample 630b of the middle coding unit 620b may include coordinates (xb, yb), and information indicating the location of the upper left sample 630c of the lower coding unit 620c may include coordinates (xc, yc). The image decoding apparatus 100 may determine the middle coding unit 620b by using the coordinates of the upper left samples 630a, 630b, and 630c which are included in the coding units 620a, 620b, and 620c, respectively. For example, when the coordinates of the upper left samples 630a, 630b, and 630c are sorted in an ascending or descending order, the coding unit 620b including the coordinates (xb, yb) of the sample 630b at a center location may be determined as a coding unit at a center location from among the coding units 620a, 620b, and 620c determined by splitting the current coding unit 600. However, the coordinates indicating the locations of the upper left samples 630a, 630b, and 630c may include coordinates indicating absolute locations in the picture, or furthermore may use coordinates (dxb, dyb) indicating a relative location of the upper left sample 630b of the middle coding unit 620b and coordinates (dxc, dyc) indicating a relative location of the upper left sample 630c of the lower coding unit 620c with respect to the location of the upper left sample 630a of the upper coding unit 620a. A method of determining a coding unit at a certain location by using coordinates of a sample included in the coding unit, as information indicating a location of the sample, is not limited to the above-described method, and may include various arithmetic methods of using the coordinates of the sample.

According to an embodiment, the image decoding apparatus 100 may split the current coding unit 600 into the plurality of coding units 620a, 620b, and 620c, and may select one of the coding units 620a, 620b, and 620c based on a certain criterion. For example, the image decoding apparatus 100 may select the coding unit 620b that has a size different from that of the others, from among the coding units 620a, 620b, and 620c.

According to an embodiment, the image decoding apparatus 100 may determine the width or height of each of the coding units 620a, 620b, and 620c by using the coordinates (xa, ya) that is the information indicating the location of the upper left sample 630a of the upper coding unit 620a, the coordinates (xb, yb) that is the information indicating the location of the upper left sample 630b of the middle coding unit 620b, and the coordinates (xc, yc) that is the information indicating the location of the upper left sample 630c of the lower coding unit 620c. The image decoding apparatus 100 may determine the respective sizes of the coding units 620a, 620b, and 620c by using the coordinates (xa, ya), (xb, yb), and (xc, yc) indicating the locations of the coding units 620a, 620b, and 620c. According to an embodiment, the image decoding apparatus 100 may determine the width of the upper coding unit 620a to be the width of the current coding unit 600. The image decoding apparatus 100 may determine the height of the upper coding unit 620a to be yb-ya. According to an embodiment, the image decoding apparatus 100 may determine the width of the middle coding unit 620b to be the width of the current coding unit 600. The image decoding apparatus 100 may determine the height of the middle coding unit 620b to be yc-yb. According to an embodiment, the image decoding apparatus 100 may determine the width or height of the lower coding unit by using the width or height of the current coding unit or the widths or heights of the upper coding unit 620a and the middle coding unit 620b. The image decoding apparatus 100 may determine a coding unit having a size different from those of the other coding units, based on the determined widths and heights of the coding units 620a, 620b, and 620c. Referring to FIG. 6, the image decoding apparatus 100 may determine the middle coding unit 620b having a size different from the sizes of the upper coding unit 620a and the lower coding unit 620c, as the coding unit of the certain location. However, the above-described method, performed by the image decoding apparatus 100, of determining a coding unit having a size different from the size of the other coding units merely corresponds to an example of determining a coding unit at a certain location by using the sizes of coding units that are determined based on coordinates of samples, and thus, various methods of determining a coding unit at a certain location by comparing the sizes of coding units that are determined based on coordinates of certain samples may be used.

The image decoding apparatus 100 may determine the width or height of each of the coding units 660a, 660b, and 660c by using the coordinates (xd, yd) that is information indicating the location of an upper left sample 670a of the left coding unit 660a, the coordinates (xe, ye) that is information indicating the location of an upper left sample 670b of the middle coding unit 660b, and the coordinates (xf, yf) that is information indicating a location of an upper left sample 670c of the right coding unit 660c. The image decoding apparatus 100 may determine the respective sizes of the coding units 660a, 660b, and 660c by using the coordinates (xd, yd), (xe, ye), and (xf, yf) indicating the locations of the coding units 660a, 660b, and 660c.

According to an embodiment, the image decoding apparatus 100 may determine the width of the left coding unit 660a to be xe-xd. The image decoding apparatus 100 may determine the height of the left coding unit 660a to be the height of the current coding unit 650. According to an embodiment, the image decoding apparatus 100 may determine the width of the middle coding unit 660b to be xf-xe. The image decoding apparatus 100 may determine the height of the middle coding unit 660b to be the height of the current coding unit 600. According to an embodiment, the image decoding apparatus 100 may determine the width or height of the right coding unit 660c by using the width or height of the current coding unit 650 or the widths or heights of the left coding unit 660a and the middle coding unit 660b. The image decoding apparatus 100 may determine a coding unit that has a size different from that of the others, based on the determined widths and heights of the coding units 660a, 660b, and 660c. Referring to FIG. 6, the image decoding apparatus 100 may determine the middle coding unit 660b having a size different from the sizes of the left coding unit 660a and the right coding unit 660c, as the coding unit of the certain location. However, the above-described method, performed by the image decoding apparatus 100, of determining a coding unit having a size different from the size of the other coding units merely corresponds to an example of determining a coding unit at a certain location by using the sizes of coding units that are determined based on coordinates of samples, and thus, various methods of determining a coding unit at a certain location by comparing the sizes of coding units that are determined based on coordinates of certain samples may be used.

However, locations of samples considered to determine locations of coding units are not limited to the above-described upper left locations, and information about arbitrary locations of samples included in the coding units may be used.

According to an embodiment, the image decoding apparatus 100 may select a coding unit at a certain location from among an odd number of coding units determined by splitting the current coding unit, by considering the shape of the current coding unit. For example, when the current coding unit has a non-square shape, a width of which is longer than a height, the image decoding apparatus 100 may determine the coding unit at the certain location in a horizontal direction. That is, the image decoding apparatus 100 may determine one of coding units at different locations in a horizontal direction and may put a restriction on the coding unit. When the current coding unit has a non-square shape, a height of which is longer than a width, the image decoding apparatus 100 may determine the coding unit at the certain location in a vertical direction. That is, the image decoding apparatus 100 may determine one of coding units at different locations in a vertical direction and may put a restriction on the coding unit.

According to an embodiment, the image decoding apparatus 100 may use information indicating respective locations of an even number of coding units so as to determine the coding unit at the certain location from among the even number of coding units. The image decoding apparatus 100 may determine an even number of coding units by splitting (binary-splitting) the current coding unit, and may determine the coding unit at the certain location by using the information about the locations of the even number of coding units. An operation related thereto may correspond to the operation of determining a coding unit at a certain location (e.g., a center location) from among an odd number of coding units, which has been described in detail above with reference to FIG. 6, and thus, detailed descriptions thereof are not provided here.

According to an embodiment, when a non-square current coding unit is split into a plurality of coding units, certain information about a coding unit at a certain location may be used in a splitting operation to determine the coding unit at the certain location from among the plurality of coding units. For example, the image decoding apparatus 100 may use at least one of block shape information or split shape mode information, which is stored in a sample included in a middle coding unit, in a splitting operation to determine a coding unit at a center location from among the plurality of coding units determined by splitting the current coding unit.

Referring to FIG. 6, the image decoding apparatus 100 may split the current coding unit 600 into the plurality of coding units 620a, 620b, and 620c based on the split shape mode information, and may determine the coding unit 620b at a center location from among the plurality of the coding units 620a, 620b, and 620c. Furthermore, the image decoding apparatus 100 may determine the coding unit 620b at the center location, in consideration of a location from which the split shape mode information is obtained. That is, the split shape mode information about the current coding unit 600 may be obtained from the sample 640 at a center location of the current coding unit 600 and, when the current coding unit 600 is split into the plurality of coding units 620a, 620b, and 620c based on the split shape mode information, the coding unit 620b including the sample 640 may be determined as the coding unit at the center location. However, information used to determine the coding unit at the center location is not limited to the split shape mode information, and various types of information may be used to determine the coding unit at the center location.

According to an embodiment, certain information for identifying the coding unit at the certain location may be obtained from a certain sample included in a coding unit to be determined. Referring to FIG. 6, the image decoding apparatus 100 may use the split shape mode information that is obtained from a sample at a certain location in the current coding unit 600 (e.g., a sample at a center location of the current coding unit 600) to determine a coding unit at a certain location from among the plurality of the coding units 620a, 620b, and 620c determined by splitting the current coding unit 600 (e.g., a coding unit at a center location from among a plurality of split coding units). That is, the image decoding apparatus 100 may determine the sample at the certain location by considering a block shape of the current coding unit 600, may determine the coding unit 620b including a sample, from which certain information (e.g., the split shape mode information) may be obtained, from among the plurality of coding units 620a, 620b, and 620c determined by splitting the current coding unit 600, and may put a certain restriction on the coding unit 620b. Referring to FIG. 6, according to an embodiment, the image decoding apparatus 100 may determine the sample 640 at the center location of the current coding unit 600 as the sample from which the certain information may be obtained, and may put a certain restriction on the coding unit 620b including the sample 640, in a decoding operation. However, the location of the sample from which the certain information may be obtained is not limited to the above-described location, and may include arbitrary locations of samples included in the coding unit 620b to be determined for a restriction.

According to an embodiment, the location of the sample from which the certain information may be obtained may be determined based on the shape of the current coding unit 600. According to an embodiment, the block shape information may indicate whether the current coding unit has a square or non-square shape, and the location of the sample from which the certain information may be obtained may be determined based on the shape. For example, the image decoding apparatus 100 may determine a sample located on a boundary for splitting at least one of a width or height of the current coding unit in half, as the sample from which the certain information may be obtained, by using at least one of information about the width of the current coding unit or information about the height of the current coding unit. As another example, when the block shape information about the current coding unit indicates a non-square shape, the image decoding apparatus 100 may determine one of samples adjacent to a boundary for splitting a long side of the current coding unit in half, as the sample from which the certain information may be obtained.

According to an embodiment, when the current coding unit is split into a plurality of coding units, the image decoding apparatus 100 may use the split shape mode information so as to determine a coding unit at a certain location from among the plurality of coding units. According to an embodiment, the image decoding apparatus 100 may obtain the split shape mode information from a sample at a certain location in a coding unit, and may split the plurality of coding units, which are generated by splitting the current coding unit, by using the split shape mode information, which is obtained from the sample of the certain location in each of the plurality of coding units. That is, a coding unit may be recursively split based on the split shape mode information that is obtained from the sample at the certain location in each coding unit. An operation of recursively splitting a coding unit has been described above with reference to FIG. 5, and thus, detailed descriptions thereof are not provided here.

According to an embodiment, the image decoding apparatus 100 may determine one or more coding units by splitting the current coding unit, and may determine an order of decoding the one or more coding units, based on a certain block (e.g., the current coding unit).

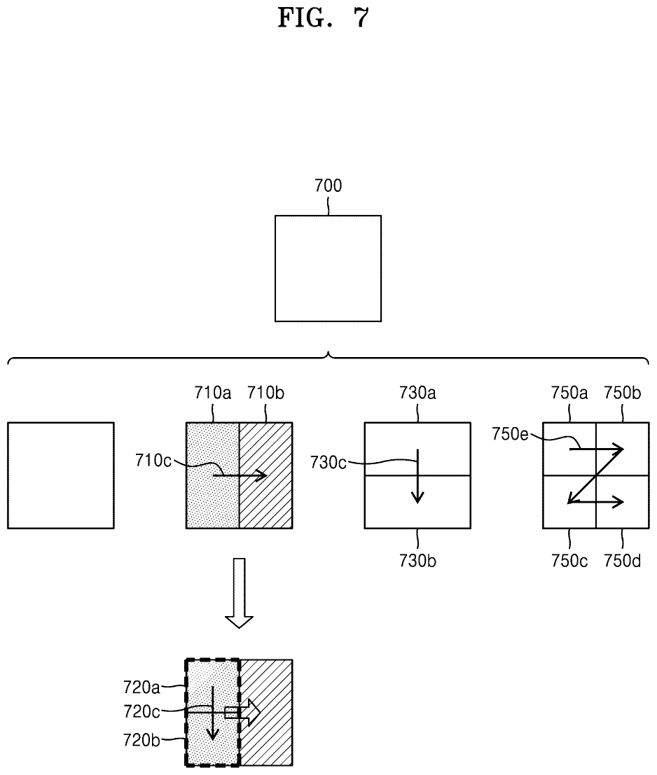

FIG. 7 illustrates an order of processing a plurality of coding units when an image decoding apparatus determines the plurality of coding units by splitting a current coding unit, according to an embodiment of the present disclosure.

According to an embodiment, the image decoding apparatus 100 may determine second coding units 710a and 710b by splitting a first coding unit 700 in a vertical direction, may determine second coding units 730a and 730b by splitting the first coding unit 700 in a horizontal direction, or may determine second coding units 750a, 750b, 750c, and 750d by splitting the first coding unit 700 in vertical and horizontal directions, based on split shape mode information.

Referring to FIG. 7, the image decoding apparatus 100 may determine to process the second coding units 710a and 710b that are determined by splitting the first coding unit 700 in a vertical direction, in a horizontal direction 710c. The image decoding apparatus 100 may determine to process the second coding units 730a and 730b that are determined by splitting the first coding unit 700 in a horizontal direction, in the vertical direction 730c. The image decoding apparatus 100 may determine to process the second coding units 750a, 750b, 750c, and 750d, which are determined by splitting the first coding unit 700 in vertical and horizontal directions, in a certain order 750e (e.g., in a raster scan order or Z-scan order) for processing coding units in a row and then processing coding units in a next row.

According to an embodiment, the image decoding apparatus 100 may recursively split coding units. Referring to FIG. 7, the image decoding apparatus 100 may determine the plurality of coding units 710a, 710b, 730a, 730b, 750a, 750b, 750c, and 750d by splitting the first coding unit 700, and may recursively split each of the determined plurality of coding units 710a, 710b, 730a, 730b, 750a, 750b, 750c, and 750d. A splitting method of the plurality of coding units 710a, 710b, 730a, 730b, 750a, 750b, 750c, and 750d may correspond to a splitting method of the first coding unit 700. Accordingly, each of the plurality of coding units 710a, 710b, 730a, 730b, 750a, 750b, 750c, and 750d may be independently split into a plurality of coding units. Referring to FIG. 7, the image decoding apparatus 100 may determine the second coding units 710a and 710b by splitting the first coding unit 700 in a vertical direction, and may determine to independently split or not to split each of the second coding units 710a and 710b.

According to an embodiment, the image decoding apparatus 100 may determine third coding units 720a and 720b by splitting the left second coding unit 710a in a horizontal direction, and may not split the right second coding unit 710b.

According to an embodiment, a processing order of coding units may be determined based on an operation of splitting a coding unit. In other words, a processing order of split coding units may be determined based on a processing order of coding units immediately before being split. The image decoding apparatus 100 may determine a processing order of the third coding units 720a and 720b determined by splitting the left second coding unit 710a, independently of the right second coding unit 710b. Because the third coding units 720a and 720b are determined by splitting the left second coding unit 710a in a horizontal direction, the third coding units 720a and 720b may be processed in a vertical direction 720c. Because the left second coding unit 710a and the right second coding unit 710b are processed in the horizontal direction 710c, the right second coding unit 710b may be processed after the third coding units 720a and 720b included in the left second coding unit 710a are processed in the vertical direction 720c. A process of determining a processing order of coding units based on a coding unit before being split is described above and not limited to the above-described example, and it should be understood that various methods may be used to independently process coding units that are split into and determined to various shapes, in a certain order.

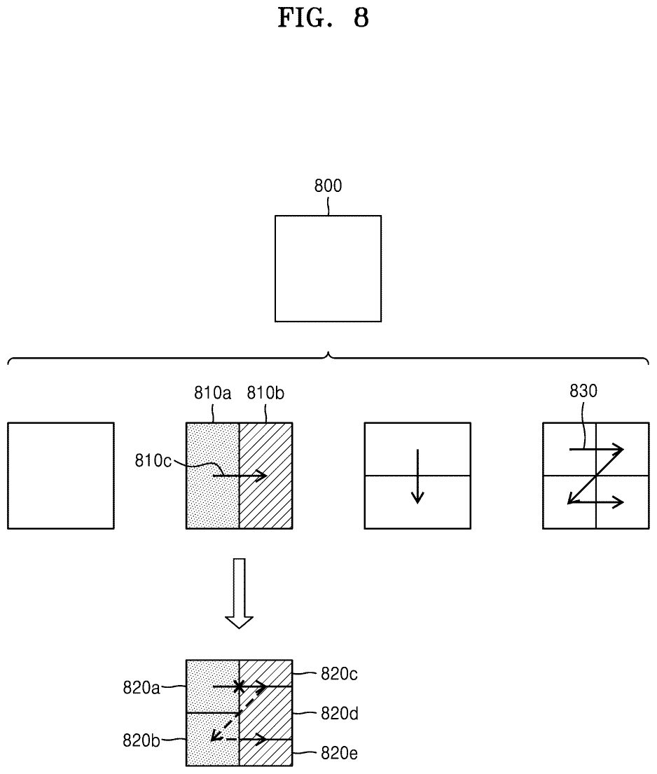

FIG. 8 illustrates a process, performed by an image decoding apparatus, of determining that a current coding unit is to be split into an odd number of coding units, when the coding units are not processable in a certain order, according to an embodiment of the present disclosure.

According to an embodiment, the image decoding apparatus 100 may determine whether the current coding unit is split into an odd number of coding units, based on obtained split shape mode information. Referring to FIG. 8, a square first coding unit 800 may be split into non-square second coding units 810a and 810b in a horizontal direction 810c, and the second coding units 810a and 810b may be independently split into third coding units 820a and 820b, and 820c, 820d and 820e. According to an embodiment, the image decoding apparatus 100 may determine the plurality of third coding units 820a and 820b by splitting the left second coding unit 810a in a horizontal direction, and may split the right second coding unit 810b into the odd number of third coding units 820c to 820e.

According to an embodiment, the image decoding apparatus 100 may determine whether there is any coding unit being split into an odd number of coding units, by determining whether the third coding units 820a and 820b, and 820c, 820d and 820e are processable in a certain order. Referring to FIG. 8, the image decoding apparatus 100 may determine the third coding units 820a and 820b, and 820c, 820d and 820e by recursively splitting the first coding unit 800. The image decoding apparatus 100 may determine whether any of the first coding unit 800, the second coding units 810a and 810b, and the third coding units 820a and 820b, and 820c, 820d and 820e are split into an odd number of coding units, based on at least one of the block shape information or the split shape mode information. For example, the right second coding unit 810b among the second coding units 810a and 810b may be split into an odd number of third coding units 820c, 820d, and 820e. A processing order of a plurality of coding units included in the first coding unit 800 may be a certain order (e.g., a Z-scan order 830), and the image decoding apparatus 100 may determine whether the third coding units 820c, 820d, and 820e, which are determined by splitting the right second coding unit 810b into an odd number of coding units, satisfy a condition for processing in the certain order.

According to an embodiment, the image decoding apparatus 100 may determine whether the third coding units 820a and 820b, and 820c, 820d and 820e included in the first coding unit 800 satisfy the condition for processing in the certain order, and the condition relates to whether at least one of widths or heights of the second coding units 810a and 810b is split in half along a boundary of the third coding units 820a and 820b, and 820c, 820d and 820e. For example, the third coding units 820a and 820b that are determined when the height of the left second coding unit 810a of the non-square shape is split in half may satisfy the condition. The image decoding apparatus 100 may determine that the third coding units 820c, 820d, and 820e do not satisfy the condition because the boundaries of the third coding units 820c, 820d, and 820e that are determined when the right second coding unit 810b is split into three coding units are unable to split the width or height of the right second coding unit 810b in half. When the condition is not satisfied as described above, the image decoding apparatus 100 may determine disconnection of a scan order, and may determine that the right second coding unit 810b is split into an odd number of coding units, based on a result of the determination. According to an embodiment, when a coding unit is split into an odd number of coding units, the image decoding apparatus 100 may put a certain restriction on a coding unit at a certain location from among the split coding units, and the restriction or the certain location is described above in various embodiments, and thus, detailed descriptions thereof are not provided here.

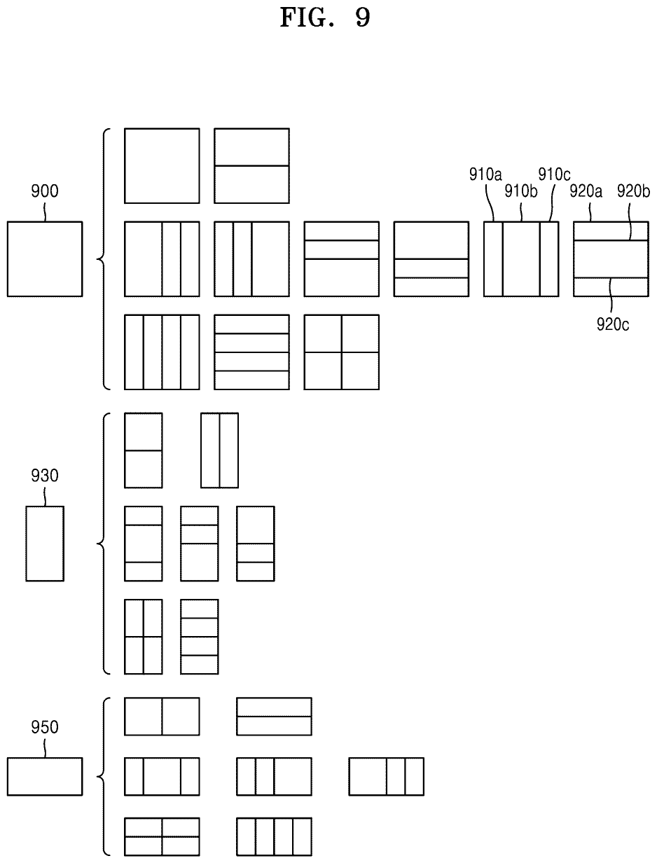

FIG. 9 illustrates a process, performed by an image decoding apparatus, of determining at least one coding unit by splitting a first coding unit, according to an embodiment of the present disclosure.

According to an embodiment, the image decoding apparatus 100 may split the first coding unit 900, based on split shape mode information obtained through the receiver 110. The square first coding unit 900 may be split into four square coding units, or may be split into a plurality of non-square coding units. For example, referring to FIG. 9, when the split shape mode information indicates to split the first coding unit 900 into non-square coding units, the image decoding apparatus 100 may split the first coding unit 900 into a plurality of non-square coding units. Specifically, when the split shape mode information indicates to determine an odd number of coding units by splitting the first coding unit 900 in a horizontal direction or a vertical direction, the image decoding apparatus 100 may split the square first coding unit 900 into an odd number of coding units that are second coding units 910a, 910b, and 910c determined by splitting the square first coding unit 900 in a vertical direction or second coding units 920a, 920b, and 920c determined by splitting the square first coding unit 900 in a horizontal direction.

According to an embodiment, the image decoding apparatus 100 may determine whether the second coding units 910a, 910b, 910c, 920a, 920b, and 920c included in the first coding unit 900 satisfy a condition for processing in a certain order, and the condition relates to whether at least one of a width or height of the first coding unit 900 is split in half along a boundary of the second coding units 910a, 910b, 910c, 920a, 920b, and 920c. Referring to FIG. 9, because boundaries of the second coding units 910a, 910b, and 910c determined by splitting the square first coding unit 900 in a vertical direction do not split the width of the first coding unit 900 in half, the image decoding apparatus 100 may determine that the first coding unit 900 does not satisfy the condition for processing in the certain order. In addition, because boundaries of the second coding units 920a, 920b, and 920c determined by splitting the square first coding unit 900 in a horizontal direction do not split the height of the first coding unit 900 in half, the image decoding apparatus 100 may determine that the first coding unit 900 does not satisfy the condition for processing in the certain order. When the condition is not satisfied as described above, the image decoding apparatus 100 may determine disconnection of a scan order, and may determine that the first coding unit 900 is split into an odd number of coding units, based on a result of the determination. According to an embodiment, when a coding unit is split into an odd number of coding units, the image decoding apparatus 100 may put a certain restriction on a coding unit at a certain location from among the split coding units, and the restriction or the certain location is described above in various embodiments, and thus, detailed descriptions thereof are not provided here.

According to an embodiment, the image decoding apparatus 100 may determine various-shaped coding units by splitting a first coding unit.

Referring to FIG. 9, the image decoding apparatus 100 may split the square first coding unit 900 or a non-square first coding unit 930 or 950 into various-shaped coding units.

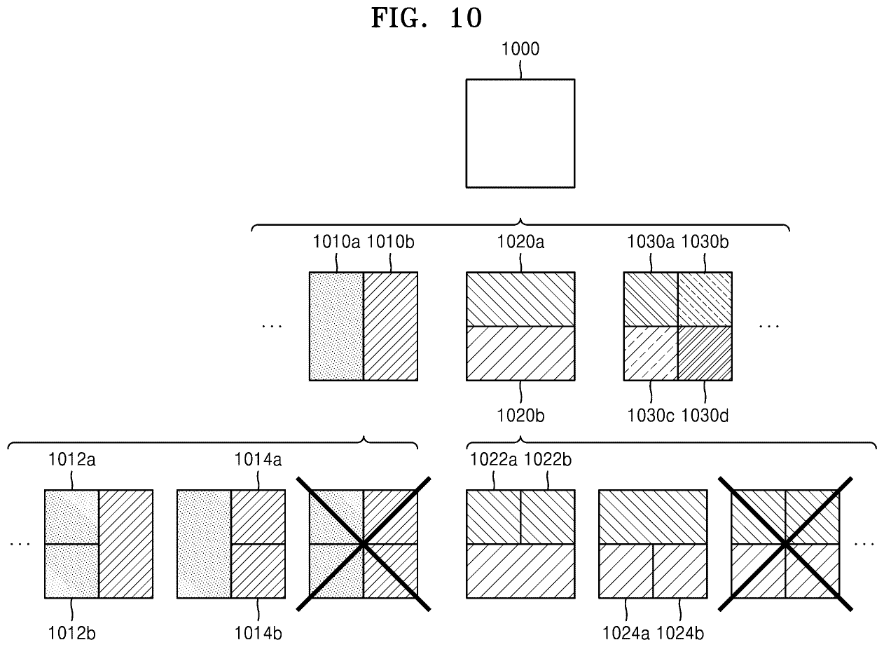

FIG. 10 illustrates that a shape into which a second coding unit is splittable is restricted when the second coding unit having a non-square shape, which is determined when an image decoding apparatus splits a first coding unit, satisfies a certain condition, according to an embodiment of the present disclosure.

According to an embodiment, the image decoding apparatus 100 may determine to split a square first coding unit 1000 into non-square second coding units 1010a, 1010b, 1020a, and 1020b, based on split shape mode information obtained through the receiver 110. The second coding units 1010a, 1010b, 1020a, and 1020b may be independently split. Accordingly, the image decoding apparatus 100 may determine to split or not to split each of the second coding units 1010a, 1010b, 1020a, and 1020b into a plurality of coding units, based on the split shape mode information about each of the second coding units 1010a, 1010b, 1020a, and 1020b. According to an embodiment, the image decoding apparatus 100 may determine third coding units 1012a and 1012b by splitting the non-square left second coding unit 1010a that is determined by splitting the first coding unit 1000 in a vertical direction, in a horizontal direction. However, when the left second coding unit 1010a is split in a horizontal direction, the image decoding apparatus 100 may restrict the right second coding unit 1010b not to be split in a horizontal direction in which the left second coding unit 1010a is split. When third coding units 1014a and 1014b are determined by splitting the right second coding unit 1010b in the same direction, the left second coding unit 1010a and the right second coding unit 1010b are independently split in a horizontal direction such that the third coding units 1012a and 1012b or 1014a and 1014b may be determined. However, this has the same result as the image decoding apparatus 100 splitting the first coding unit 1000 into four square second coding units 1030a, 1030b, 1030c, and 1030d based on the split shape mode information, and may be inefficient in terms of image decoding.

According to an embodiment, the image decoding apparatus 100 may determine third coding units 1022a and 1022b or 1024a and 1024b by splitting the non-square second coding unit 1020a or 1020b which is determined by splitting the first coding unit 1000 in a horizontal direction, in a vertical direction. However, when a second coding unit (e.g., the upper second coding unit 1020a) is split in a vertical direction, for the above-described reason, the image decoding apparatus 100 may restrict the other second coding unit (e.g., the lower second coding unit 1020b) not to be split in a vertical direction in which the upper second coding unit 1020a is split.

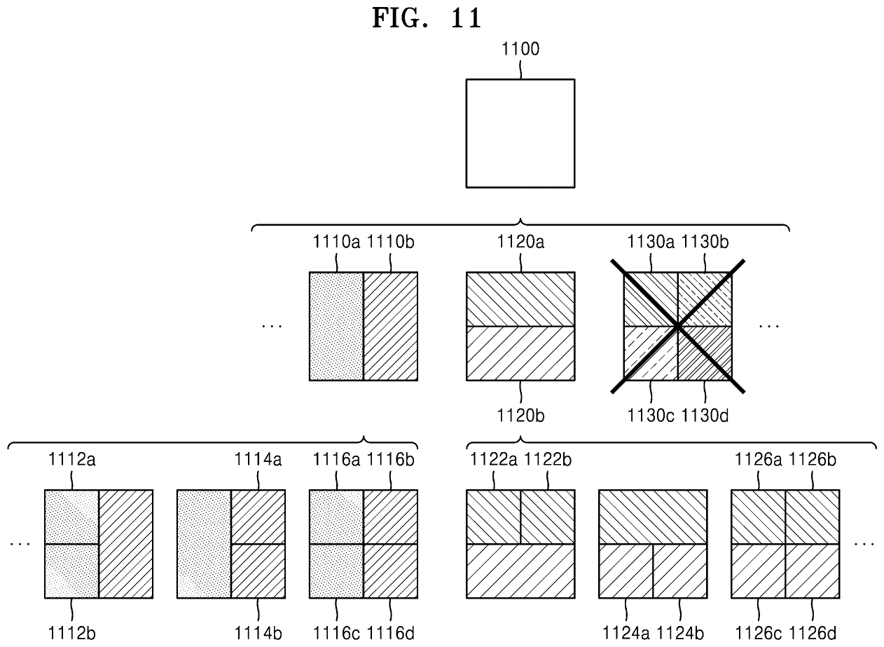

FIG. 11 illustrates a process, performed by an image decoding apparatus, of splitting a square coding unit when split shape mode information is unable to indicate that the square coding unit is split into four square coding units, according to an embodiment of the present disclosure.

According to an embodiment, the image decoding apparatus 100 may determine second coding units 1110a, 1110b, 1120a, 1120b, etc. by splitting a first coding unit 1100, based on split shape mode information. The split shape mode information may include information about various methods of splitting a coding unit, but the information about various splitting methods may not include information for splitting a coding unit into four square coding units. According to such split shape mode information, the image decoding apparatus 100 may not split the square first coding unit 1100 into four square second coding units 1130a, 1130b, 1130c, and 1130d. Based on the split shape mode information, the image decoding apparatus 100 may determine the non-square second coding units 1110a, 1110b, 1120a, 1120b, etc.

According to an embodiment, the image decoding apparatus 100 may independently split the non-square second coding units 1110a, 1110b, 1120a, 1120b, etc. Each of the second coding units 1110a, 1110b, 1120a, 1120b, etc. may be recursively split in a certain order, and this splitting method may correspond to a method of splitting the first coding unit 1100, based on the split shape mode information.

For example, the image decoding apparatus 100 may determine square third coding units 1112a and 1112b by splitting the left second coding unit 1110a in a horizontal direction, and may determine square third coding units 1114a and 1114b by splitting the right second coding unit 1110b in a horizontal direction. Furthermore, the image decoding apparatus 100 may determine square third coding units 1116a, 1116b, 1116c, and 1116d by splitting both of the left and right second coding units 1110a and 1110b in a horizontal direction. In this case, coding units having the same shape as the four square second coding units 1130a, 1130b, 1130c, and 1130d split from the first coding unit 1100 may be determined.

As another example, the image decoding apparatus 100 may determine square third coding units 1122a and 1122b by splitting the upper second coding unit 1120a in a vertical direction, and may determine square third coding units 1124a and 1124b by splitting the lower second coding unit 1120b in a vertical direction. Furthermore, the image decoding apparatus 100 may determine square third coding units 1126a, 1126b, 1126c, and 1126d by splitting both of the upper and lower second coding units 1120a and 1120b in a vertical direction. In this case, coding units having the same shape as the four square second coding units 1130a, 1130b, 1130c, and 1130d split from the first coding unit 1100 may be determined.

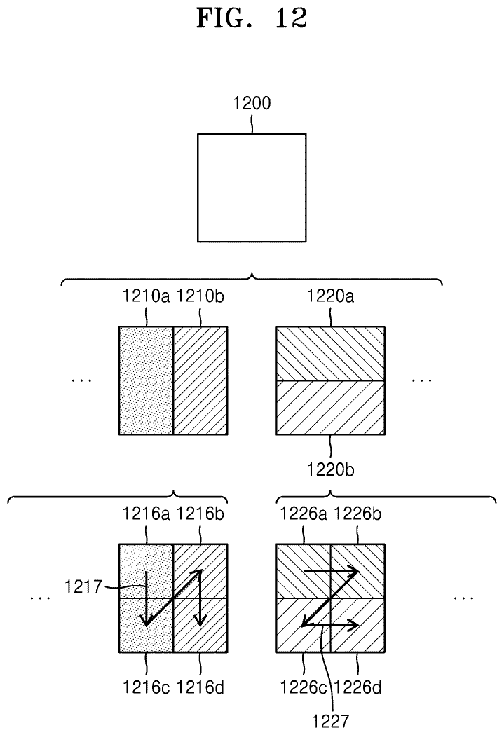

FIG. 12 illustrates that a processing order between a plurality of coding units may be changed depending on a process of splitting a coding unit, according to an embodiment of the present disclosure.

According to an embodiment, the image decoding apparatus 100 may split a first coding unit 1200, based on split shape mode information. When a block shape indicates a square shape and the split shape mode information indicates to split the first coding unit 1200 in at least one of a horizontal direction or a vertical direction, the image decoding apparatus 100 may determine second coding units (e.g., second coding units 1210a, 1210b, 1220a, 1220b, etc.) by splitting the first coding unit 1200. Referring to FIG. 12, the non-square second coding units 1210a, 1210b, 1220a, and 1220b determined by splitting the first coding unit 1200 in only a horizontal direction or vertical direction may be independently split based on the split shape mode information about each coding unit. For example, the image decoding apparatus 100 may determine third coding units 1216a, 1216b, 1216c, and 1216d by splitting the second coding units 1210a and 1210b, which are generated by splitting the first coding unit 1200 in a vertical direction, in a horizontal direction, and may determine third coding units 1226a, 1226b, 1226c, and 1226d by splitting the second coding units 1220a and 1220b, which are generated by splitting the first coding unit 1200 in a horizontal direction, in a horizontal direction. A process of splitting the second coding units 1210a, 1210b, 1220a, and 1220b is described above with reference to FIG. 11, and thus, detailed descriptions thereof are not provided here.

According to an embodiment, the image decoding apparatus 100 may process coding units in a certain order. The characteristics of processing coding units in a certain order are described above with reference to FIG. 7, and thus, detailed descriptions thereof are not provided here. Referring to FIG. 12, the image decoding apparatus 100 may determine four square third coding units 1216a, 1216b, 1216c, and 1216d, and 1226a, 1226b, 1226c, and 1226d by splitting the square first coding unit 1200. According to an embodiment, the image decoding apparatus 100 may determine processing orders of the third coding units 1216a, 1216b, 1216c, and 1216d, and 1226a, 1226b, 1226c, and 1226d, based on a splitting method of the first coding unit 1200.

According to an embodiment, the image decoding apparatus 100 may determine the third coding units 1216a, 1216b, 1216c, and 1216d by splitting the second coding units 1210a and 1210b generated by splitting the first coding unit 1200 in a vertical direction, in a horizontal direction, and may process the third coding units 1216a, 1216b, 1216c, and 1216d in a processing order 1217 for first processing the third coding units 1216a and 1216c, which are included in the left second coding unit 1210a, in a vertical direction and then processing the third coding unit 1216b and 1216d, which are included in the right second coding unit 1210b, in a vertical direction.

According to an embodiment, the image decoding apparatus 100 may determine the third coding units 1226a, 1226b, 1226c, and 1226d by splitting the second coding units 1220a and 1220b generated by splitting the first coding unit 1200 in a horizontal direction, in a vertical direction, and may process the third coding units 1226a, 1226b, 1226c, and 1226d in a processing order 1227 for first processing the third coding units 1226a and 1226b, which are included in the upper second coding unit 1220a, in a horizontal direction and then processing the third coding unit 1226c and 1226d, which are included in the lower second coding unit 1220b, in a horizontal direction.

Referring to FIG. 12, the square third coding units 1216a, 1216b, 1216c, and 1216d, and 1226a, 1226b, 1226c, and 1226d may be determined by splitting the second coding units 1210a and 1210b, and 1220a and 1220b, respectively. The second coding units 1210a and 1210b determined by splitting the first coding unit 1200 in a vertical direction have different shapes from the second coding units 1220a and 1220b determined by splitting the first coding unit 1200 in a horizontal direction, but, according to the third coding units 1216a, 1216b, 1216c, and 1216d, and 1226a, 1226b, 1226c, and 1226d which are determined thereafter, the first coding unit 1200 is eventually split into coding units of the same shape. Accordingly, by recursively splitting a coding unit through different processes based on the split shape mode information, even though coding units having the same shape are eventually determined, the image decoding apparatus 100 may process the plurality of coding units determined to have the same shape in different orders.

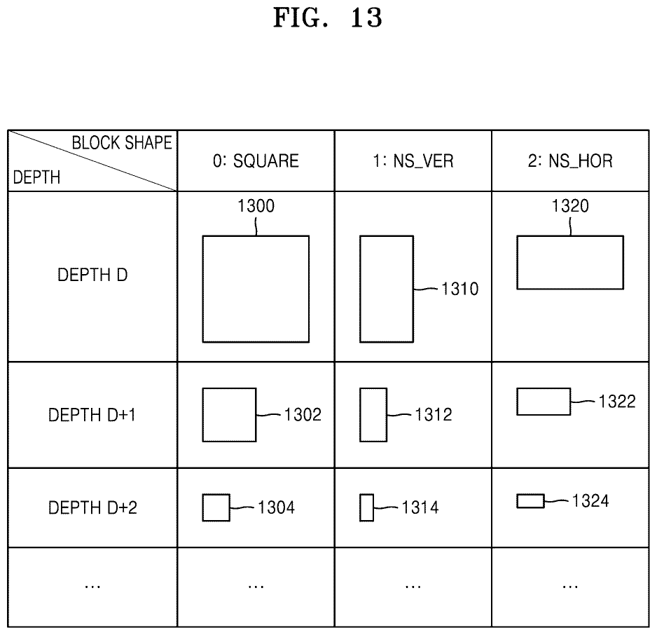

FIG. 13 illustrates a process of determining a depth of a coding unit as a shape and size of the coding unit change, when the coding unit is recursively split such that a plurality of coding units are determined, according to an embodiment of the present disclosure.

According to an embodiment, the image decoding apparatus 100 may determine the depth of the coding unit, based on a certain criterion. For example, the certain criterion may be the length of a long side of the coding unit. When the length of a long side of a coding unit before being split is 2n times (n>0) the length of a long side of a split current coding unit, the image decoding apparatus 100 may determine that a depth of the current coding unit is increased from a depth of the coding unit before being split, by n. Hereinafter, a coding unit having an increased depth is expressed as a coding unit of a lower depth.

Referring to FIG. 13, according to an embodiment, the image decoding apparatus 100 may determine a second coding unit 1302 and a third coding unit 1304 of lower depths by splitting a square first coding unit 1300 based on block shape information indicating a square shape (e.g., the block shape information may be expressed as ‘0: SQUARE’). Assuming that the size of the square first coding unit 1300 is 2N×2N, the second coding unit 1302 determined by splitting a width and height of the first coding unit 1300 in ½ may have a size of N×N. Furthermore, the third coding unit 1304 determined by splitting a width and height of the second coding unit 1302 in ½ may have a size of N/2×N/2. In this case, a width and height of the third coding unit 1304 are ¼ times those of the first coding unit 1300. When a depth of the first coding unit 1300 is D, a depth of the second coding unit 1302, the width and height of which are ½ times those of the first coding unit 1300, may be D+1, and a depth of the third coding unit 1304, the width and height of which are ¼ times those of the first coding unit 1300, may be D+2.

According to an embodiment, the image decoding apparatus 100 may determine a second coding unit 1312 or 1322 and a third coding unit 1314 or 1324 of lower depths by splitting a non-square first coding unit 1310 or 1320 based on block shape information indicating a non-square shape (e.g., the block shape information may be expressed as ‘1: NS_VER’ indicating a non-square shape, a height of which is longer than a width, or as ‘2: NS_HOR’ indicating a non-square shape, a width of which is longer than a height).

The image decoding apparatus 100 may determine a second coding unit (e.g., the second coding unit 1302, 1312, or 1322) by splitting at least one of a width or a height of the first coding unit 1310 having a size of N×2N. That is, the image decoding apparatus 100 may determine the second coding unit 1302 having a size of N×N or the second coding unit 1322 having a size of N×N/2 by splitting the first coding unit 1310 in a horizontal direction, or may determine the second coding unit 1312 having a size of N/2×N by splitting the first coding unit 1310 in horizontal and vertical directions.

According to an embodiment, the image decoding apparatus 100 may determine the second coding unit (e.g., the second coding unit 1302, 1312, or 1322) by splitting at least one of a width or a height of the first coding unit 1320 having a size of 2N×N. That is, the image decoding apparatus 100 may determine the second coding unit 1302 having a size of N×N or the second coding unit 1312 having a size of N/2×N by splitting the first coding unit 1320 in a vertical direction, or may determine the second coding unit 1322 having a size of N×N/2 by splitting the first coding unit 1320 in horizontal and vertical directions.

According to an embodiment, the image decoding apparatus 100 may determine a third coding unit (e.g., the third coding unit 1304, 1314, or 1324) by splitting at least one of a width or a height of the second coding unit 1302 having a size of N×N. That is, the image decoding apparatus 100 may determine the third coding unit 1304 having a size of N/2×N/2, the third coding unit 1314 having a size of N/4×N/2, or the third coding unit 1324 having a size of N/2×N/4 by splitting the second coding unit 1302 in vertical and horizontal directions.

According to an embodiment, the image decoding apparatus 100 may determine the third coding unit (e.g., the third coding unit 1304, 1314, or 1324) by splitting at least one of a width or a height of the second coding unit 1312 having a size of N/2×N. That is, the image decoding apparatus 100 may determine the third coding unit 1304 having a size of N/2×N/2 or the third coding unit 1324 having a size of N/2×N/4 by splitting the second coding unit 1312 in a horizontal direction, or may determine the third coding unit 1314 having a size of N/4×N/2 by splitting the second coding unit 1312 in vertical and horizontal directions.

According to an embodiment, the image decoding apparatus 100 may determine the third coding unit (e.g., the third coding unit 1304, 1314, or 1324) by splitting at least one of a width or a height of the second coding unit 1322 having a size of N×N/2. That is, the image decoding apparatus 100 may determine the third coding unit 1304 having a size of N/2×N/2 or the third coding unit 1314 having a size of N/4×N/2 by splitting the second coding unit 1322 in a vertical direction, or may determine the third coding unit 1324 having a size of N/2×N/4 by splitting the second coding unit 1322 in vertical and horizontal directions.

According to an embodiment, the image decoding apparatus 100 may split the square coding unit (e.g., the square coding unit 1300, 1302, or 1304) in a horizontal or vertical direction. For example, the image decoding apparatus 100 may determine the first coding unit 1310 having a size of N×2N by splitting the first coding unit 1300 having a size of 2N×2N in a vertical direction, or may determine the first coding unit 1320 having a size of 2N×N by splitting the first coding unit 1300 in a horizontal direction. According to an embodiment, when a depth is determined based on the length of the longest side of a coding unit, a depth of a coding unit determined by splitting the first coding unit 1300 having a size of 2N×2N in a horizontal or vertical direction may be the same as the depth of the first coding unit 1300.

According to an embodiment, a width and height of the third coding unit 1314 or 1324 may be ¼ times those of the first coding unit 1310 or 1320. When a depth of the first coding unit 1310 or 1320 is D, a depth of the second coding unit 1312 or 1322, the width and height of which are ½ times those of the first coding unit 1310 or 1320, may be D+1, and a depth of the third coding unit 1314 or 1324, the width and height of which are ¼ times those of the first coding unit 1310 or 1320, may be D+2.

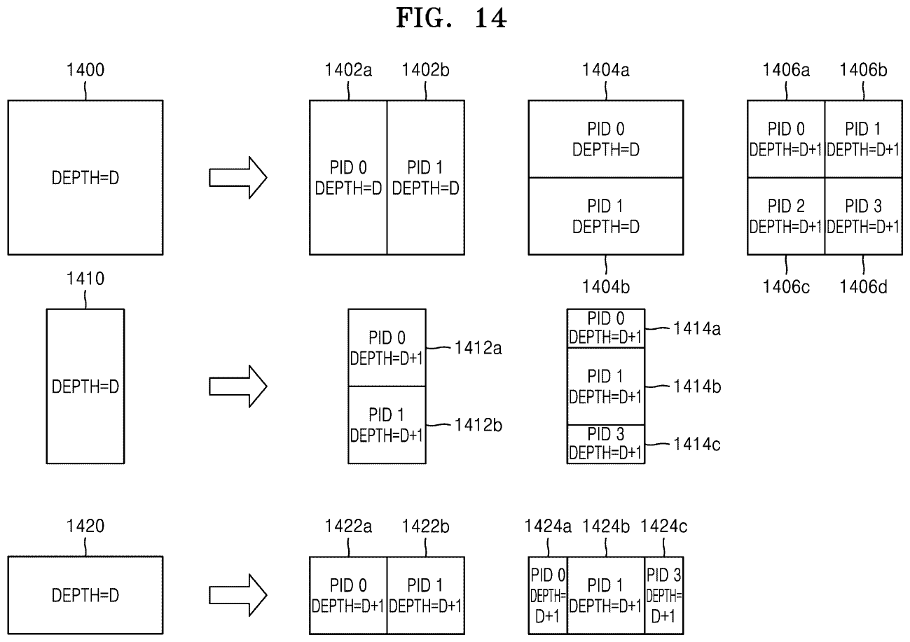

FIG. 14 illustrates depths that are determinable based on shapes and sizes of coding units, and part indexes (PIDs) that are for distinguishing the coding units, according to an embodiment of the present disclosure.

According to an embodiment, the image decoding apparatus 100 may determine various-shape second coding units by splitting a square first coding unit 1400. Referring to FIG. 14, the image decoding apparatus 100 may determine second coding units 1402a and 1402b, 1404a and 1404b, and 1406a, 1406b, 1406c, and 1406d by splitting the first coding unit 1400 in at least one of a vertical direction or a horizontal direction based on split shape mode information. That is, the image decoding apparatus 100 may determine the second coding units 1402a and 1402b, 1404a and 1404b, and 1406a, 1406b, 1406c, and 1406d, based on the split shape mode information about the first coding unit 1400.

According to an embodiment, depths of the second coding units 1402a and 1402b, 1404a and 1404b, and 1406a, 1406b, 1406c, and 1406d, which are determined based on the split shape mode information about the square first coding unit 1400, may be determined based on the length of a long side thereof. For example, because the length of a side of the square first coding unit 1400 is the same as the length of a long side of the non-square second coding units 1402a and 1402b, and 1404a and 1404b, the first coding unit 1400 and the non-square second coding units 1402a and 1402b, and 1404a and 1404b may have the same depth, e.g., D. However, when the image decoding apparatus 100 splits the first coding unit 1400 into the four square second coding units 1406a, 1406b, 1406c, and 1406d based on the split shape mode information, because the length of a side of the square second coding units 1406a, 1406b, 1406c, and 1406d is ½ times the length of a side of the first coding unit 1400, depths of the second coding units 1406a, 1406b, 1406c, and 1406d may be D+1 which is lower than the depth D of the first coding unit 1400 by 1.

According to an embodiment, the image decoding apparatus 100 may determine a plurality of second coding units 1412a and 1412b, and 1414a, 1414b, and 1414c by splitting a first coding unit 1410, a height of which is longer than a width, in a horizontal direction based on the split shape mode information. According to an embodiment, the image decoding apparatus 100 may determine a plurality of second coding units 1422a and 1422b, and 1424a, 1424b, and 1424c by splitting a first coding unit 1420, a width of which is longer than a height, in a vertical direction based on the split shape mode information.

According to an embodiment, depths of the second coding units 1412a and 1412b, and 1414a, 1414b, and 1414c, or 1422a and 1422b, and 1424a, 1424b, and 1424c that are determined based on the split shape mode information about the non-square first coding unit 1410 or 1420 may be determined based on the length of a long side thereof. For example, because the length of a side of the square second coding units 1412a and 1412b is ½ times the length of a long side of the first coding unit 1410 having a non-square shape, a height of which is longer than a width, depths of the square second coding units 1412a and 1412b is D+1 which is lower than the depth D of the non-square first coding unit 1410 by 1.

Furthermore, the image decoding apparatus 100 may split the non-square first coding unit 1410 into an odd number of second coding units 1414a, 1414b, and 1414c based on the split shape mode information. The odd number of second coding units 1414a, 1414b, and 1414c may include the non-square second coding units 1414a and 1414c and the square second coding unit 1414b. In this case, because the length of a long side of the non-square second coding units 1414a and 1414c and the length of a side of the square second coding unit 1414b are ½ times the length of a long side of the first coding unit 1410, depths of the second coding units 1414a, 1414b, and 1414c may be D+1 which is lower than the depth D of the non-square first coding unit 1410 by 1. The image decoding apparatus 100 may determine depths of coding units split from the first coding unit 1420 having a non-square shape, a width of which is longer than a height, by using the above-described method of determining depths of coding units split from the first coding unit 1410.

According to an embodiment, the image decoding apparatus 100 may determine PIDs for identifying split coding units, based on a size ratio between the coding units when an odd number of split coding units do not have the same size. Referring to FIG. 14, a coding unit 1414b of a center location among an odd number of split coding units 1414a, 1414b, and 1414c may have the same width as those of the other coding units 1414a and 1414c and a height which is two times those of the other coding units 1414a and 1414c. That is, in this case, the coding unit 1414b at the center location may include two of the other coding unit 1414a or 1414c. Therefore, when a PID of the coding unit 1414b at the center location is 1 based on a scan order, a PID of the coding unit 1414c located next to the coding unit 1414b may be increased by 2 and thus, may be 3. That is, discontinuity in PID values may be present. According to an embodiment, the image decoding apparatus 100 may determine whether an odd number of split coding units do not have equal sizes, based on whether discontinuity is present in PIDs for identifying the split coding units.

According to an embodiment, the image decoding apparatus 100 may determine whether to use a specific splitting method, based on PID values for identifying a plurality of coding units determined by splitting a current coding unit. Referring to FIG. 14, the image decoding apparatus 100 may determine an even number of coding units 1412a and 1412b or an odd number of coding units 1414a, 1414b, and 1414c by splitting the first coding unit 1410 having a rectangular shape, a height of which is longer than a width. The image decoding apparatus 100 may use PIDs indicating respective coding units so as to identify the respective coding units. According to an embodiment, the PID may be obtained from a sample of a certain location of each coding unit (e.g., an upper left sample).

According to an embodiment, the image decoding apparatus 100 may determine a coding unit at a certain location from among the split coding units, by using the PIDs for distinguishing the coding units. According to an embodiment, when the split shape mode information about the first coding unit 1410 having a rectangular shape, a height of which is longer than a width, indicates to split a coding unit into three coding units, the image decoding apparatus 100 may split the first coding unit 1410 into the three coding units 1414a, 1414b, and 1414c. The image decoding apparatus 100 may assign a PID to each of the three coding units 1414a, 1414b, and 1414c. The image decoding apparatus 100 may compare PIDs of an odd number of split coding units so as to determine a coding unit at a center location from among the coding units. The image decoding apparatus 100 may determine the coding unit 1414b having a PID corresponding to a middle value among the PIDs of the coding units, as the coding unit at the certain location from among the coding units determined by splitting the first coding unit 1410. According to an embodiment, the image decoding apparatus 100 may determine PIDs for distinguishing split coding units, based on a size ratio between the coding units when the split coding units do not have the same size. Referring to FIG. 14, the coding unit 1414b generated by splitting the first coding unit 1410 may have the same width as those of the other coding units 1414a and 1414c and a height which is two times that of the other coding units 1414a and 1414c. In this case, when the PID of the coding unit 1414b at the center location is 1, the PID of the coding unit 1414c located next to the coding unit 1414b may be increased by 2 and thus, may be 3. When the PID is not uniformly increased as described above, the image decoding apparatus 100 may determine that a coding unit is split into a plurality of coding units including a coding unit having a size different from that of the other coding units. According to an embodiment, when the split shape mode information indicates to split a coding unit into an odd number of coding units, the image decoding apparatus 100 may split a current coding unit in such a manner that a coding unit of a certain location among an odd number of coding units (e.g., a coding unit of a center location) has a size different from that of the other coding units. In this case, the image decoding apparatus 100 may determine the coding unit of the center location, which has a different size, by using PIDs of the coding units. However, the PIDs and the size or location of the coding unit of the certain location are specified to describe an embodiment, and thus, are not limited to the above-described examples, and various PIDs and various locations and sizes of coding units may be used.

According to an embodiment, the image decoding apparatus 100 may use a certain data unit where a coding unit starts to be recursively split.

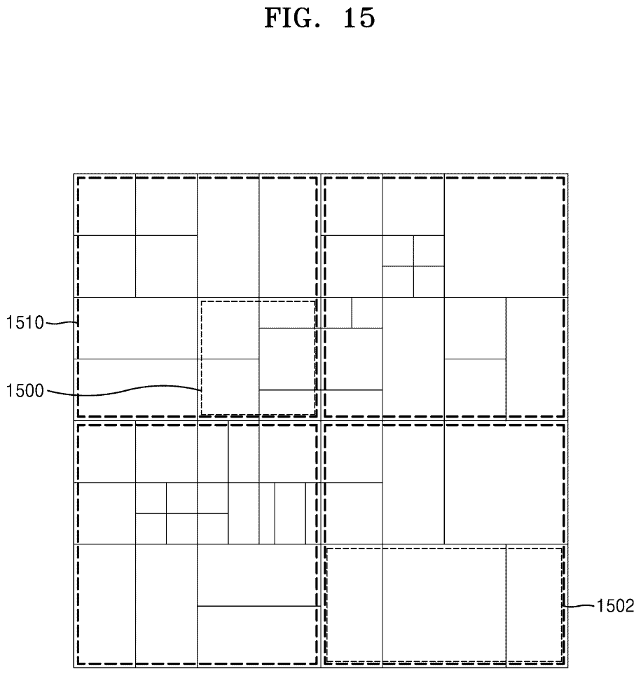

FIG. 15 illustrates that a plurality of coding units are determined based on a plurality of certain data units included in a picture, according to an embodiment of the present disclosure.

According to an embodiment, a certain data unit may be defined as a data unit where a coding unit starts to be recursively split by using split shape mode information. That is, the certain data unit may correspond to a coding unit of an uppermost depth, which is used to determine a plurality of coding units split from a current picture. Hereinafter, for convenience of description, the certain data unit is referred to as a reference data unit.

According to an embodiment, the reference data unit may have a certain size and a certain size shape. According to an embodiment, the reference data unit may include M×N samples. Herein, M and N may be equal to each other, and may be integers expressed as powers of 2. That is, the reference data unit may have a square or non-square shape, and may be then split into an integer number of coding units.

According to an embodiment, the image decoding apparatus 100 may split the current picture into a plurality of reference data units. According to an embodiment, the image decoding apparatus 100 may split the plurality of reference data units, which are split from the current picture, by using the split shape mode information about each reference data unit. The process of splitting the reference data unit may correspond to a splitting process using a quadtree structure.

According to an embodiment, the image decoding apparatus 100 may previously determine the smallest size allowed for the reference data units included in the current picture. Accordingly, the image decoding apparatus 100 may determine various reference data units having sizes equal to or greater than the smallest size, and may determine one or more coding units by using the split shape mode information with respect to the determined reference data unit.

Referring to FIG. 15, the image decoding apparatus 100 may use a square reference coding unit 1500 or a non-square reference coding unit 1502. According to an embodiment, the shape and size of reference coding units may be determined based on various data units capable of including one or more reference coding units (e.g., sequences, pictures, slices, slice segments, tiles, tile groups, largest coding units, etc.)

According to an embodiment, the receiver 110 of the image decoding apparatus 100 may obtain, from a bitstream, at least one of reference coding unit shape information or reference coding unit size information with respect to each of the various data units. A process of splitting the square reference coding unit 1500 into one or more coding units is described above with reference to the process of splitting the current coding unit 300 of FIG. 3, and a process of splitting the non-square reference coding unit 1502 into one or more coding units is described above with reference to the process of splitting the current coding unit 400 or 450 of FIG. 4, and thus, detailed descriptions thereof are not provided here.

According to an embodiment, the image decoding apparatus 100 may use a PID for identifying the size and shape of reference coding units, to determine the size and shape of reference coding units according to some data units previously determined based on a certain condition. That is, the receiver 110 may obtain, from the bitstream, only the PID for identifying the size and shape of reference coding units with respect to each slice, slice segment, tile, tile group, or largest coding unit which is a data unit satisfying a certain condition (e.g., a data unit having a size equal to or smaller than a slice) among the various data units (e.g., sequences, pictures, slices, slice segments, tiles, tile groups, largest coding units, etc.) The image decoding apparatus 100 may determine the size and shape of reference data units with respect to each data unit, which satisfies the certain condition, by using the PID. When the reference coding unit shape information and the reference coding unit size information are obtained and used from the bitstream according to each data unit having a relatively small size, efficiency of using the bitstream may not be high, and thus, only the PID may be obtained and used instead of directly obtaining the reference coding unit shape information and the reference coding unit size information. In this case, at least one of the size or shape of reference coding units corresponding to the PID for identifying the size and shape of reference coding units may be previously determined. That is, the image decoding apparatus 100 may determine at least one of the size or the shape of reference coding units included in a data unit serving as a unit for obtaining the PID, by selecting the previously determined at least one of the size or the shape of reference coding units based on the PID.

According to an embodiment, the image decoding apparatus 100 may use one or more reference coding units included in a largest coding unit. That is, a largest coding unit split from a picture may include one or more reference coding units, and coding units may be determined by recursively splitting each reference coding unit. According to an embodiment, at least one of a width or a height of the largest coding unit may be integer times at least one of the width or the height of the reference coding units. According to an embodiment, the size of reference coding units may be obtained by splitting the largest coding unit n times based on a quadtree structure. That is, the image decoding apparatus 100 may determine the reference coding units by splitting the largest coding unit n times based on a quadtree structure, and may split the reference coding unit based on at least one of the block shape information or the split shape mode information according to various embodiments.

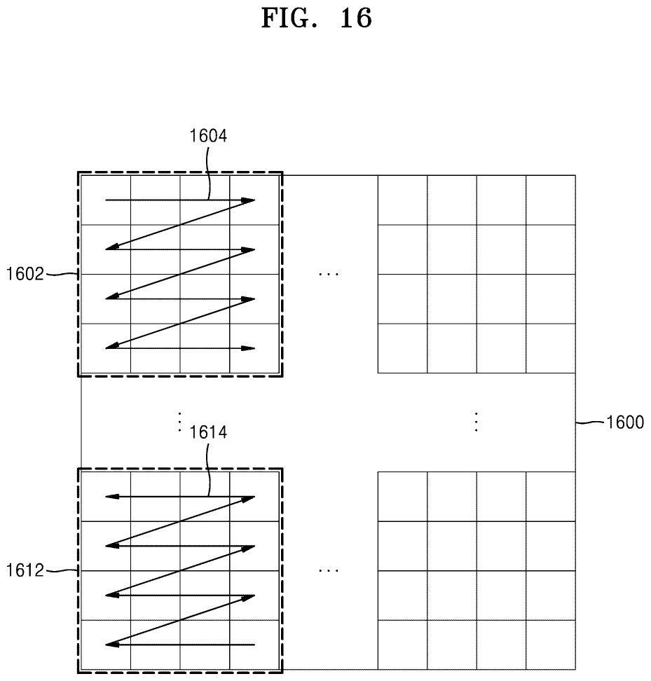

FIG. 16 illustrates a processing block serving as a unit for determining a determination order of reference coding units included in a picture, according to an embodiment of the present disclosure.

According to an embodiment, the image decoding apparatus 100 may determine one or more processing blocks split from a picture. The processing block is a data unit including one or more reference coding units split from a picture, and the one or more reference coding units included in the processing block may be determined according to a specific order. That is, a determination order of one or more reference coding units determined in each processing block may correspond to one of various types of orders for determining reference coding units, and may vary depending on the processing block. The determination order of reference coding units, which is determined with respect to each processing block, may be one of various orders, e.g., raster scan order, Z-scan, N-scan, up-right diagonal scan, horizontal scan, and vertical scan, but is not limited to the above-described scan orders.

According to an embodiment, the image decoding apparatus 100 may obtain processing block size information and may determine the size of one or more processing blocks included in the picture. The image decoding apparatus 100 may obtain the processing block size information from a bitstream and may determine the size of one or more processing blocks included in the picture. The size of processing blocks may be a certain size of data units, which is indicated by the processing block size information.

According to an embodiment, the receiver 110 of the image decoding apparatus 100 may obtain the processing block size information from the bitstream according to each specific data unit. For example, the processing block size information may be obtained from the bitstream in a data unit such as an image, sequence, picture, slice, slice segment, tile, or tile group. That is, the receiver 110 may obtain the processing block size information from the bitstream according to each of the various data units, and the image decoding apparatus 100 may determine the size of one or more processing blocks, which are split from the picture, by using the obtained processing block size information. The size of the processing blocks may be integer times that of the reference coding units.

According to an embodiment, the image decoding apparatus 100 may determine the size of processing blocks 1602 and 1612 included in the picture 1600. For example, the image decoding apparatus 100 may determine the size of processing blocks based on the processing block size information obtained from the bitstream. Referring to FIG. 16, according to an embodiment, the image decoding apparatus 100 may determine a width of the processing blocks 1602 and 1612 to be four times the width of the reference coding units, and may determine a height of the processing blocks 1602 and 1612 to be four times the height of the reference coding units. The image decoding apparatus 100 may determine a determination order of one or more reference coding units in one or more processing blocks.

According to an embodiment, the image decoding apparatus 100 may determine the processing blocks 1602 and 1612, which are included in the picture 1600, based on the size of processing blocks, and may determine a determination order of one or more reference coding units in the processing blocks 1602 and 1612. According to an embodiment, determination of reference coding units may include determination of the size of the reference coding units.

According to an embodiment, the image decoding apparatus 100 may obtain, from the bitstream, determination order information about one or more reference coding units included in one or more processing blocks, and may determine a determination order of one or more reference coding units based on the obtained determination order information. The determination order information may be defined as an order or direction for determining the reference coding units in the processing block. That is, the determination order of reference coding units may be independently determined with respect to each processing block.

According to an embodiment, the image decoding apparatus 100 may obtain, from the bitstream, the determination order information about reference coding units according to each specific data unit. For example, the receiver 110 may obtain the determination order information about reference coding units from the bitstream according to each data unit such as an image, sequence, picture, slice, slice segment, tile, tile group, or processing block. Because the determination order information about reference coding units indicates an order for determining reference coding units in a processing block, the determination order information may be obtained with respect to each specific data unit including an integer number of processing blocks.

According to an embodiment, the image decoding apparatus 100 may determine one or more reference coding units based on the determined determination order

According to an embodiment, the receiver 110 may obtain the determination order information about reference coding units from the bitstream as information related to the processing blocks 1602 and 1612, and the image decoding apparatus 100 may determine a determination order of one or more reference coding units included in the processing blocks 1602 and 1612 and determine one or more reference coding units, which are included in the picture 1600, based on the determination order. Referring to FIG. 16, the image decoding apparatus 100 may determine determination orders 1604 and 1614 of one or more reference coding units in the processing blocks 1602 and 1612, respectively. For example, when the determination order information about reference coding units is obtained for each processing block, determination orders of reference coding units related to the processing blocks 1602 and 1612 may be different for each processing block. When the determination order 1604 of reference coding units in the processing block 1602 is a raster scan order, reference coding units included in the processing block 1602 may be determined according to the raster scan order. On the contrary, when the determination order 1614 of reference coding units in the other processing block 1612 is a backward raster scan order, reference coding units included in the processing block 1612 may be determined according to the backward raster scan order.

According to an embodiment, the image decoding apparatus 100 may decode the determined one or more reference coding units. The image decoding apparatus 100 may decode an image, based on the reference coding units determined in the embodiment described above. A method of decoding the reference coding units may include various image decoding methods.

According to an embodiment, the image decoding apparatus 100 may obtain block shape information indicating the shape of a current coding unit or split shape mode information indicating a splitting method of the current coding unit, from the bitstream, and may use the obtained information. The split shape mode information may be included in the bitstream related to various data units. For example, the image decoding apparatus 100 may use the split shape mode information included in a sequence parameter set, a picture parameter set, a video parameter set, a slice header, a slice segment header, a tile header, or a tile group header. Furthermore, the image decoding apparatus 100 may obtain, from the bitstream, a syntax element corresponding to the block shape information or the split shape mode information according to each largest coding unit, each reference coding unit, or each processing block, and may use the obtained syntax element.

Hereinafter, a method of determining a split rule according to an embodiment of the present disclosure will be described in detail.

The image decoding apparatus 100 may determine a split rule of an image. The split rule may be predetermined between the image decoding apparatus 100 and the image encoding apparatus 2200. The image decoding apparatus 100 may determine the split rule of the image, based on information obtained from a bitstream. The image decoding apparatus 100 may determine the split rule based on the information obtained from at least one of a sequence parameter set, a picture parameter set, a video parameter set, a slice header, a slice segment header, a tile header, or a tile group header. The image decoding apparatus 100 may determine the split rule differently according to frames, slices, tiles, temporal layers, largest coding units, or coding units.

The image decoding apparatus 100 may determine the split rule based on a block shape of a coding unit. The block shape may include a size, shape, a ratio of width and height, and a direction of the coding unit. The image encoding apparatus 2200 and the image decoding apparatus 100 may pre-determine to determine the split rule based on the block shape of the coding unit. However, the present disclosure is not limited thereto. The image decoding apparatus 100 may determine the split rule based on the information obtained from the bitstream received from the image encoding apparatus 2200.

The shape of the coding unit may include a square and a non-square. When the lengths of the width and height of the coding unit are the same, the image decoding apparatus 100 may determine the shape of the coding unit to be a square. In addition, when the lengths of the width and height of the coding unit are not the same, the image decoding apparatus 100 may determine the shape of the coding unit to be a non-square.

The size of the coding unit may include various sizes such as 4×4, 8×4, 4×8, 8×8, 16×4, 16×8, . . . , 256×256. The size of the coding unit may be classified based on the length of a long side of the coding unit, the length of a short side, or the area. The image decoding apparatus 100 may apply the same split rule to coding units classified as the same group. For example, the image decoding apparatus 100 may classify coding units having the same lengths of the long sides as having the same size. In addition, the image decoding apparatus 100 may apply the same split rule to coding units having the same lengths of long sides.

The ratio of the width and height of the coding unit may include 1:2, 2:1, 1:4, 4:1, 1:8, 8:1, 1:16, 16:1, 32:1, 1:32, etc. In addition, a direction of the coding unit may include a horizontal direction and a vertical direction. The horizontal direction may indicate a case in which the length of the width of the coding unit is longer than the length of the height thereof. The vertical direction may indicate a case in which the length of the width of the coding unit is shorter than the length of the height thereof.

The image decoding apparatus 100 may adaptively determine the split rule based on the size of the coding unit. The image decoding apparatus 100 may differently determine an allowable split shape mode based on the size of the coding unit. For example, the image decoding apparatus 100 may determine whether splitting is allowed based on the size of the coding unit. The image decoding apparatus 100 may determine a split direction according to the size of the coding unit. The image decoding apparatus 100 may determine an allowable split type according to the size of the coding unit.

The split rule determined based on the size of the coding unit may be a split rule predetermined between the image encoding apparatus 2200 and the image decoding apparatus 100. In addition, the image decoding apparatus 100 may determine the split rule based on the information obtained from the bitstream.

The image decoding apparatus 100 may adaptively determine the split rule based on a location of the coding unit. The image decoding apparatus 100 may adaptively determine the split rule based on the location of the coding unit in the image.

In addition, the image decoding apparatus 100 may determine the split rule such that coding units generated through different splitting paths do not have the same block shape. However, the present disclosure is not limited thereto, and the coding units generated through different splitting paths have the same block shape. The coding units generated through the different splitting paths may have different decoding processing orders. The decoding processing orders is described above with reference to FIG. 12, and thus, details thereof are not provided again.

In the specification, a template refers to a neighboring pixel region or a neighboring block that is adjacent to a current block and reconstructed before the current block. The neighboring pixel region or the neighboring block corresponding to the template may include at least one neighboring pixel (or reference pixel) adjacent to a block. For example, the template may refer to a neighboring pixel region or a neighboring block adjacent to the left of the block. For example, the template may refer to a neighboring pixel region or a neighboring block adjacent to the top of the block. For example, the template may refer to neighboring pixel regions or neighboring blocks adjacent to the left and top of the block. For example, the template may refer to a neighboring pixel region or a neighboring block adjacent to at least one of the left, top, or top left of the block.

In the specification, template matching (TM) refers to a technique of finding a template (or pixel region) that best matches a template of the block (or neighboring pixel region adjacent to the block). For example, TM may be used as a method of predicting a block based on the template that best matches the template of the block (e.g., coding unit (CU)) in a reference picture or a current picture, or as a method of deriving motion information about a decoder side that refines the motion information about the block. In the specification, intra TM may refer to a technique of finding the template that best matches the template of the block in a picture (or current picture) including the block. In the specification, template matching prediction (TMP) may refer to a technique of performing prediction based on TM.

In the specification, boundary filtering refers to filtering for removing discontinuity occurring at a boundary between blocks.

Referring to FIGS. 17 to 20, intra prediction methods based on templates and intra prediction methods based on templates in which boundary filtering is additionally performed according to an embodiment of the present disclosure are described.

FIG. 17 is a diagram for describing an TMP method according to an embodiment of the present disclosure.

Referring to FIG. 17, an L-shaped template region 1720 including reference samples located on the left of a current block 1710, reference samples located on the top left of the current block 1710, and reference samples located on the top of the current block 1710 is determined for intra prediction of the current block 1710. A region including a region reconstructed before a current largest coding unit 1730 including the current block 1710 and a reconstructed region located on the top left of the current block 1710 is used as a search region 1740. Specifically, a degree of distortion is measured by matching the template region 1730with a plurality of regions of sizes corresponding to the template region 1720 of the current block 1710 in the search region 1740. For example, a region that best matches is determined by calculating the distortion cost using a sum of absolute difference (SAD). A matching block corresponding to the current block 1710 is determined based on the region that best matches. Just as the template region 1720 is located around the current block 1710, the region that best matches corresponding to the template region 1720 of the current block 1710 is located in the search region 1740 around the matching block. For example, a matching block 1760 corresponding to a region 1750 that best matches in the search region 1740 is used. That is, a value of the matching block 1760 is determined as a predicted value of the current block 1710.

A size of the search region 1740 is proportional to a width W and a height H of the current block 1710. That is, a width of the search region 1740 is α·W, and a height of the search region 1740 is α·H. This is because the larger the current block 1710, the more advantageous for prediction it is to search for a wide region. On the other hand, FIG. 17 shows that the search region 1740 does not include a top reference region and a left reference region except for a top left reference region of the current block 1710 in the current largest coding unit 1730, but is not limited thereto. For example, the search region 1740 may include all reconstructed reference regions in the current largest coding unit 1730.

In this case, the template region 1720 and the search region 1740 are reconstructed regions before in-loop filtering is performed on a current picture including the current block 1710. Therefore, when the template region 1720 and the search region 1740 are used as they are, prediction results may be inefficient due to the discontinuity of a block boundary. Thus, smoothing or filtering is necessary to address this discontinuity.

Referring back to FIG. 17, boundary filtering is performed on the block boundary in the template region 1720 of the current block 1710 with respect to the template region 1720 of the current block 1710. Boundary filtering is performed on one of a plurality of regions in the search region 1740 having a size corresponding to the filtered template region 1720. A region that best matches with the filtered template region 1720 among the plurality of regions is determined by comparing the filtered template region 1720 with one filtered region. A matching block corresponding to the current block 1710 is determined based on the region 1750 that matches the best. Boundary filtering is performed on the matching block. The current block 1710 is predicted based on the filtered matching block 1760.

Boundary filtering on the template region 1720 is filtering for removing discontinuity at a boundary between coding units, a boundary between largest coding units, a slice split boundary, or a block boundary in the template region 1720.

Boundary filtering on a region corresponding to the template region 1720 in the search region 1740 is filtering for removing discontinuity at a boundary between coding units, a boundary between largest coding units, a slice split boundary, or a block boundary in the region corresponding to the template region 1720 in the search region 1740.

Boundary filtering on the matching block 1760 is filtering for removing discontinuity at a boundary between coding units, a boundary between largest coding units, a slice split boundary, or a block boundary in the matching block 1760.

Boundary filtering on the template region 1720, boundary filtering on the region corresponding to the template region 1720 in the search region 1740, and boundary filtering on the matching block 1760 are all independently operable. In addition, boundary filtering on the template region 1720, boundary filtering on the region corresponding to template region 1720 in the search region 1740, and boundary filtering on the matching block 1760 may be the same filtering or different filtering. For example, boundary filtering on template region 1720, boundary filtering on the region corresponding to the template region 1720 in the search region 1740, and boundary filtering on the matching block 1760 may be filtering of [1 2 1].

A predictor may be generated based on TM without transmitting intra prediction mode related information, and inefficiency arising from a reconstructed region to which in-loop filtering is not applied may be eliminated and an accurate predictor may be generated by using boundary filtering.

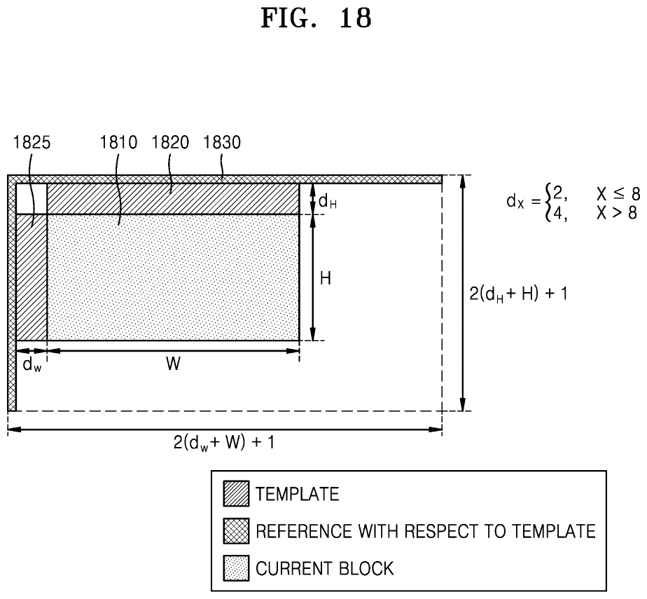

FIG. 18 is a diagram for describing a template-based intra mode derivation (TIMD) method according to an embodiment of the present disclosure.

Referring to FIG. 18, for intra prediction of a current block 1810, a top reference region 1820 located on the top of the current block 1810 and a left reference region 1825 located on the left of the current block 1810 are determined as template regions. Reference samples 1830 with respect to the template regions are determined. According to predetermined prediction modes (e.g., one or two intra prediction modes with the smallest value by calculating the distortion cost using SAD from an MPM list including modes with a high probability of being selected) by using the reference samples 1830 on the template regions, predicted values with respect to the template regions are determined by performing intra prediction on the template regions. A sum of absolute transformed difference (SATD) is calculated using a difference between the predicted values with respect to the template regions and already reconstructed values of the template regions. Among all SATD values of the predetermined prediction modes, one to two minimum SATD costs are selected, and one to two intra modes corresponding thereto are derived. The current block 1810 is predicted based on the derived intra mode.

A height dH of the top reference region 1820 is determined to be 2 when the height of the current block 1810 is less than 8, and is determined to be 4 when the height of the current block 1810 is greater than 8. A width dW of the left reference region 1825 is determined to be 2 when the width of the current block 1810 is less than 8, and is determined to be 4 when the width of the current block 1810 is greater than 8.

In this case, the template regions 1820 and 1825 and the reference samples 1830 are reconstructed regions before in-loop filtering is performed on a current picture including the current block 1810. Therefore, when the template regions 1820 and 1825 and the reference samples 1830 are used as they are, prediction results may be inefficient due to the discontinuity of a block boundary. Thus, smoothing or filtering is necessary to address this discontinuity.

Referring back to FIG. 18, boundary filtering is performed on the reference samples 1830 with respect to the template regions. According to each of the predetermined prediction modes using the filtered reference samples 1830, predicted values with respect to the template regions are determined by performing intra prediction on the template regions. Boundary filtering is performed on the predicted values with respect to the template regions. A SATD is calculated using a difference between the predicted values of the filtered template regions and the already reconstructed values of the template regions. Among all SATD values of the predetermined prediction modes, one to two minimum SATD costs are selected, and one to two intra modes corresponding thereto are derived. The current block 1810 is predicted based on the derived intra mode.

Boundary filtering on the reference samples 1830 with respect to the template regions is filtering for removing discontinuity at a boundary between coding units, a boundary between largest coding units, a slice split boundary, or a block boundary in regions of reference samples in the template regions.

Boundary filtering on the predicted values with respect to the template regions is filtering for removing discontinuity at a boundary between coding units, a boundary between largest coding units, a slice split boundary, or a block boundary in regions of the predicted values with respect to the template regions.

Both boundary filtering on the reference samples 1830 with respect to the template regions and boundary filtering on the predicted values with respect to the template regions are independently operable. In addition, boundary filtering on the reference samples 1830 with respect to the template regions and boundary filtering on the predicted values with respect to the template regions may be the same filtering or different filtering. For example, boundary filtering on the reference samples 1830 with respect to the template regions and boundary filtering on the predicted values with respect to the template regions may be filtering of [1 2 1].

A predictor may be generated by deriving an intra mode based on a template without transmitting intra prediction mode related information, and inefficiency arising from a reconstructed region to which in-loop filtering is not applied may be eliminated and an accurate predictor may be generated by using boundary filtering.

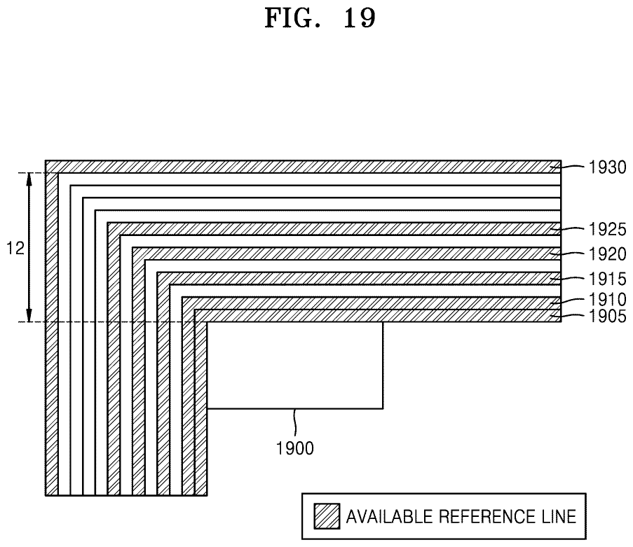

FIG. 19 is a diagram for describing a method of using a template-based multiple reference line (TMRL) according to an embodiment of the present disclosure.

Referring to FIG. 19, pixels with the same pixel spacing from a current block 1900 are grouped and determined as a template, and prediction is performed using pixels located in the selected template. Specifically, reference samples 1905 adjacent to the current block 1900 are determined as a first reference line, reference samples 1910 at a 1-pixel distance from the current block 1900 are determined as a second reference line, reference samples 1915 at a 3-pixel distance from the current block 1900 are determined as a third reference line, reference samples 1920 at a 5-pixel distance from the current block 1900 are determined as a fourth reference line, reference samples 1925 at a 7-pixel distance from the current block 1900are determined as a fifth reference line, and reference samples 1930 at a 12-pixel distance from the current block 1900 are determined as a sixth reference line. A reference line is referred to by a reference line index. For example, the first reference line may have a reference line index of 0, the second reference line may have a reference line index of 1, the third reference line may have a reference line index of 3, the fourth reference line may have a reference line index of 5, the fifth reference line may have a reference line index of 7, and the sixth reference line may have a reference line index of 12. For intra prediction of the current block 1900, the current block 1900 may be predicted by performing prediction using one of the first reference line to the sixth reference line according to the reference line index. The reference line index may be determined by an encoding side through a rate distance optimization (RDO) calculation and transmitted to a decoding side.

In this case, template regions corresponding to the first reference line to the sixth reference line are reconstructed regions before in-loop filtering is performed on a current picture including the current block 1900. Therefore, when one of the template regions is used as it is, a prediction result may be inefficient due to the discontinuity of a block boundary. Thus, smoothing or filtering is necessary to address this discontinuity.

Referring back to FIG. 19, boundary filtering is performed on one of the first reference line to the sixth reference line, and a reference line with the lowest cost is determined by performing prediction based on the filtered one reference line and comparing costs. The reference line with the lowest cost is selected. The cost may be calculated through SAD or SATD. The current block 1900 is predicted based on the filtered reference line with the lowest cost.

Boundary filtering on one of the first reference line to the sixth reference line is filtering for removing discontinuity at a boundary between coding units, a boundary between largest coding units, a slice split boundary, or a block boundary in one of the first reference line to the sixth reference line.

A predictor may be generated without transmitting intra prediction mode related information, by selecting one of a plurality of reference lines and using boundary filtering, and inefficiency arising from a reconstructed region to which in-loop filtering is not applied may be eliminated and an accurate predictor may be generated by using boundary filtering.

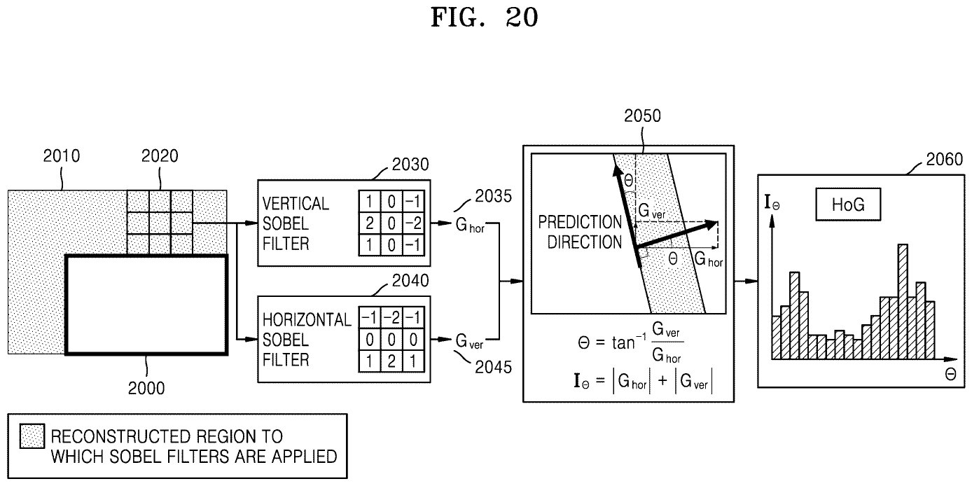

FIG. 20 is a diagram for describing a decoder-side intra mode derivation (DIMD) method according to an embodiment of the present disclosure.

Referring to FIG. 20, a gradient is obtained by applying two filters of 3×3 size to a reconstructed region 2010 located around a current block 2000. Specifically, a horizontal gradient Ghor 2035 is obtained by applying a vertical Sobel filter 2030 to the reconstructed region 2010, for example reconstructed region 2020, and a vertical gradient Gver 2045 is obtained by applying a horizontal Sobel filter 2040 to the reconstructed region 2010. A prediction direction 2050 is determined using the horizontal gradient 2035 and the vertical gradient 2045.

Specifically, an angle of the prediction direction 2050 is determined as shown in Equation 1 below, and the intensity of the prediction direction 2050 is determined as shown in Equation 2 below.

$$θ = {tan}^{- 1} \frac{{G}_{ver}}{{G}_{hor}} \qquad [ Equation l ]$$

$${I}_{θ} = \vert {G}_{hor} \vert + \vert {G}_{ver} \vert \qquad [ Equation 2 ]$$

A histogram of gradient (HOG) 2060 is determined using gradients of all locations with respect to the reconstructed region 2010, and two directional intra prediction modes are derived based on the intensity of the HOG. The current block 2000 is predicted based on the two directional intra prediction modes.

In this case, the reconstructed regions 2010 are reconstructed regions before in-loop filtering is performed on a current picture including the current block 2000. Therefore, when the reconstructed region 2010 is used as it is, a prediction result may be inefficient due to the discontinuity of a block boundary. Thus, smoothing or filtering is necessary to address this discontinuity.

Referring back to FIG. 20, boundary filtering is performed on the reconstructed region 2010, and the vertical Sobel filter 2030 and the horizontal Sobel filter 2040 are applied to the filtered reconstructed region 2010. As a result of applying a Sobel filter, the horizontal gradient 2035 and the vertical gradient 2045 are obtained, and the prediction direction 2050 is determined using the horizontal gradient 2035 and the vertical gradient 2045. A HOG is determined using gradients of all locations with respect to the filtered reconstructed region 2010, and two directional intra prediction modes are derived based on the intensity of the HOG. The current block 2000 is predicted based on the two directional intra prediction modes.

Boundary filtering on the reconstructed region 2010 is filtering for removing discontinuity at a boundary between coding units, a boundary between largest coding units, a slice split boundary, or a block boundary in the reconstructed region 2010.

A predictor may be generated without transmitting intra prediction mode related information, by using a reconstructed region to which boundary filtering is applied, and inefficiency arising from a reconstructed region to which in-loop filtering is not applied may be eliminated and an accurate predictor may be generated by using boundary filtering.

A boundary filtering method according to an embodiment of the present disclosure will be described in detail with reference to FIGS. 21 to 22.

FIG. 21 is a diagram for describing a method of applying boundary filtering according to an embodiment of the present disclosure.

Referring to FIG. 21, when neighboring blocks located on the top of a current block 2100 are used as template regions, noise values may be caused by a boundary 2105 located on the left of a first top neighboring block 2110 and a boundary 2115 located between the first top neighboring block 2110 and a second top neighboring block 2120.

In addition, when neighboring blocks located on the left of the current block 2100 are used as template regions, noise values may be caused by a boundary 2125 located below a first left neighboring block 2130 and a boundary 2135 located between the first left neighboring block 2130 and a second left neighboring block 2140.

A part with a noticeable discontinuity in a reconstructed region before in-loop filtering is applied is a boundary between blocks. When a block is split into coding units, largest coding units, slices, etc., the block may be split according to an object in the block, but may be split according to various other conditions. At this time, when the reconstructed region is used immediately, error values that may occur at the boundary between blocks are also used as information, which may lead to reduced accuracy in deriving an accurate prediction mode or generating a predictor. Therefore, it is necessary to apply a kind of deblocking effect to the reconstructed region by performing smoothing or filtering in this boundary part before a decoder itself derives a prediction mode or generates a predictor by using TM.

Referring back to FIG. 21, when a top area of the current block 2100 is used as a template, a noise value that may be caused by the boundary of blocks may be removed by applying smoothing or filtering to the boundary 2105 located on the left of the first top neighboring block 2110 and the boundary 2115 located between the first top neighboring block 2110 and the second top neighboring block 2120. In addition, a noise value may be removed by removing pixels at the boundary 2105 located on the left of the first top neighboring block 2110 and the boundary 2111 located between the first top neighboring block 2110 and the second top neighboring block 2120.

When a left region of the current block 2100 is used as a template, a noise value that may be caused by the boundary of blocks may be removed by applying smoothing or filtering to the boundary 2125 located below the first left neighboring block 2130 and the boundary 2135 located between the first left neighboring block 2130 and the second left neighboring block 2140. In addition, a noise value may be removed by removing pixels at the boundary 2125 below the first left neighboring block 2130 and the boundary 2135 between the first left neighboring block 2130 and the second left neighboring block 2140.

In addition, instead of smoothing or filtering all block boundaries in a used reconstructed region, smoothing or filtering may be performed in consideration of a prediction mode of the block and a location of the block in an image. Specifically, when intra prediction modes of the first top neighboring block 2110 and the second top neighboring block 2120 are different from each other, there is a high probability that the characteristics of the picture will be reflected in the reconstructed region. Therefore, when intra modes of the first top neighboring block 2110 and the second top neighboring block 2120 are different from each other or intra prediction modes of the first top neighboring block 2110 and the second top neighboring block 2120 are directional modes and opposite to each other, it may be determined that a pixel with a stronger discontinuity exists at the boundary of the block, and thus, a filter with a high filtering intensity may be used. When it is determined that intra prediction modes of the first top neighboring block 2110 and the second top neighboring block 2120 are similar to each other, a filter with a weak filtering intensity may be used or application of smoothing or filtering may be omitted. In addition, when intra prediction modes of the first left neighboring block 2130 and the second left neighboring block 2140 are different from each other, there is a high probability that the characteristics of the picture will be reflected in the reconstructed region. Therefore, when intra modes of the first left neighboring block 2130 and the second left neighboring block 2140 are different from each other or intra prediction modes of the first left neighboring block 2130 and the second left neighboring block 2140 are directional modes and opposite to each other, it may be determined that a pixel with a stronger discontinuity exists at the boundary of the block, and thus, a filter with a high filtering intensity may be used. When it is determined that intra prediction modes of the first left neighboring block 2130 and the second left neighboring block 2140 are similar to each other, a filter with a weak filtering intensity may be used or application of smoothing or filtering may be omitted.

As shown in Table 1 below, the type of a filter may be determined according to intra modes of blocks CU1 and CU2 adjacent to each other. That is, when the intra mode of CU1 and the intra mode of CU2 are different from each other, a filtering type may be determined as a recon smoothing filter 1, and when the intra mode of CU1 and the intra mode of CU2 are the same, the filtering type may be determined as a recon smoothing filter 2.

TABLE 1

| Intra mode | Filtering type |
|---|---|
| CU1.intra_mode ≠ CU2.intra_mode | Recon Smoothing Filter 1 |
| CU1.intra_mode == CU2.intra_mode | Recon Smoothing Filter2 |

In addition, when predictors are generated independently, such as an intra block copy (IBC) mode or a matrix-based intra prediction (MIP) mode, completely different predictors may be generated even when the two modes are the same. Discontinuity may be removed by applying filtering to an intra mode that generates a predictor.

As shown in Table 2 below, in the case of an intra mode that generates a predictor, a filtering type may be determined according to conditions below.

TABLE 2

| CU1 intra mode | CU2 intra mode | Filtering type |
|---|---|---|
| IBC | IBC | Recon Smoothing Filter1 |
| MIP | IBC | |
| IBC | MIP | |
| MIP | MIP | |
| MIP | General Intra mode | |
| General Intra mode | MIP | |
| IBC | General Intra mode | |
| General Intra mode | IBC | |
| General Intra mode | General Intra mode | Recon Smoothing Filter2 |

In addition as shown in FIG. 21, when the reconstructed region includes the boundary between the blocks, the intensity or method of smoothing or filtering may vary in consideration of a difference between the two blocks and the characteristics of the block.

The characteristics of the block may be the width W, the height H, an area, or an aspect ratio of the block. Specifically, the characteristics of the block may refer to at least one of W, H, log 2W, log 2H, log 2W+log 2H, log 2WH, WH, log 2(W/H), W/H, log 2(H/W), or H/W. For example, when the area (log 2W+log 2H) of the block is referred to as the characteristic of the block, the intensity or method of edge filtering of a reference pixel on the top or left of the current block may be determined differently according to the area of the current block 2100, as shown in Table 3.

TABLE 3

| Block Size (log2W + log21) | Filtering type |
|---|---|
| Block size < 8 | Recon Smoothing Filter1 |
| Block size ≥ 8 | Recon Smoothing Filter2 |

FIG. 22 is a diagram for describing a method of applying boundary filtering according to an embodiment of the present disclosure.

Referring to FIG. 22, a first current block 2210 obtained by splitting a first upper block 2200 is relatively larger than neighboring blocks of the first current block 2210. In this case, when the neighboring blocks are used as template regions, a plurality of edge components may be reflected in the template regions. Thus, strong smoothing or filtering may be required. On the other hand, a second current block 2260 obtained by splitting a second upper block 2250 is relatively smaller than neighboring blocks of the second current block 2260. In this case, when the neighboring blocks are used as template regions, an edge exists but may be negligible. Thus, weak smoothing or weak filtering may be more effective.

In addition, when smoothing or filtering is applied to a boundary between two blocks in a reconstructed region, the intensity or method of smoothing or filtering may be determined differently in consideration of the characteristics of texture inside the two blocks.

When a block with a complex texture is included in the two blocks, a difference in pixel values of the two blocks at the boundary of the blocks may be large. In order to define the texture of the reconstructed region, a type of filtering may be determined by defining texture complexity (TC) as shown in Equation 3 below.

$$TC = \frac{2}{height \times width} ( {\sum }_{\text{?} = Zn - 1}^{weight} {\sum }_{\text{?} = Zn - 1}^{width} \vert p ( i , j ) - mean \vert + {\sum }_{\text{?} = Zn - 1}^{height} {\sum }_{\text{?} = Zn - 1}^{width} \vert p ( i , j ) - mean \vert ) n = 1 , 2 , … \qquad [ Equation 3 ]$$

$$\text{?} \text{indicates text missing or illegible when filed}$$

Here, height is a height of the block, width is a width of the block, and mean is an average value of pixels in the block.

Thus, when the TC is greater than a certain threshold, strong smoothing or strong filtering may be applied by determining that the boundary between the two blocks is large, and when the TC is less than the certain threshold, weaker smoothing or weaker filtering may be applied or filtering may be omitted. As shown in Table 4 below, the filtering type may be determined according to the TC.

TABLE 4

| Texture complexity (TC) | Filtering type |
|---|---|
| TC <= Threshold | Recon Smoothing Filter1 |
| TC > Threshold | Recon Smoothing Filter2 |

In addition, smoothing or filtering may be determined differently according to the number of blocks in the reconstructed region. Specifically, when the number of blocks adjacent to top and left boundaries of a current block is s (s>=1), smoothing or filtering may be determined differently through information about s blocks.

Referring to FIG. 22, when a prediction mode is derived or a predictor is generated by defining reference samples of a top area as templates, in the case of the first current block 2210, when N or more blocks (N=3) are on the top of the first current block 2210, a plurality of edge components may be reflected in a template region. Thus, strong smoothing or strong filtering may be required. On the other hand, in the case of the second current block 2260, when one block is on the top of the second current block 2260, an edge exists, but may be negligible. Thus, weak smoothing or weak filtering may be more effective.

The filtering type may be determined differently according to the number of blocks in the template region as shown in Table 5 below.

TABLE 5

| Number of split blocks X (N >= 1) | Filtering type |
|---|---|
| X <= N | Recon Smoothing Filter1 |
| X > N | Recon Smoothing Filter2 |

According to an embodiment of the present disclosure, smoothing or filtering on the template region may be used only in an MPM mode, and when it is not the MPM mode, smoothing or filtering is not applied, and the determined intra mode may be used as it is.

According to an embodiment of the present disclosure, smoothing or filtering on the template region may be used only in a directional mode, and when it is not the directional mode, smoothing or filtering is not applied, and an existing reconstructed region may be used as it is.

According to an embodiment of the present disclosure, smoothing or filtering on the template region may be used only in a specific block size. For example, smoothing or filtering may be set to be used only on a block having an area greater than or equal to M×N. Alternatively, smoothing or filtering may be set to be used when M or N is greater than a specific value.

According to an embodiment of the present disclosure, smoothing or filtering on the template region may be separately performed for each color component. In addition, smoothing or filtering on the template region may be performed only in a specific color component. Specifically, smoothing or filtering on the template region may be performed only in a luma component.

In addition, smoothing or filtering itself on the template region may be performed only in the luma component, and a result of performing smoothing or filtering in the luma component may be used as it is in a chroma component. Alternatively, smoothing or filtering of the chroma component may be separately performed based on the reconstructed region on which smoothing or filtering has been performed in the luma component.

According to an embodiment of the present disclosure, a flag may be used to determine whether to apply smoothing or filtering to the template region. Specifically, the flag is defined as recon_smoothing_flag, and when a value of the flag is 0, it may be determined to use the given reconstructed region as it is, and when the value of the flag is 1, it may be determined to use the reconstructed region after smoothing the edge between blocks. In addition, when recon_smoothing_flag does not exist, the value of the flag may be set to be inferred as 0.

According to an embodiment of the present disclosure, smoothing or filtering on the template region may be applied by selecting a preset filter. In addition, the filter may be adaptively applied according to whether smoothing or filtering has been applied to a block in a template region. For example, isReconFiltered is defined as a flag indicating whether smoothing or filtering has been applied to a reconstructed region corresponding to a template when a decoding side intra tool is searched on a template basis. When a value of isReconFiltered is 1, smoothing or filtering has been applied to the reconstructed region, and when the value of isReconFiltered is 0, smoothing or filtering has not been applied to the reconstructed region. When isReconFiltered is not transmitted, the value of isReconFiltered is inferred to be 0. When the value of isReconFiltered is 1, because smoothing or filtering has already been applied to the reconstructed region, no additional smoothing or filtering is applied to the reconstructed region, and the reconstructed region is used as a template. On the contrary, when the value of isReconFiltered is 0, smoothing or filtering is applied to the reconstructed region and the filtered reconstructed region is used as a template.

According to an embodiment of the present disclosure, a filter may be adaptively applied by presetting which filter to use when smoothing or filtering is applied to a block edge and transmitting an index. Specifically, recon_smoothing_filterType_idx defines an index determined to preset which filter to use. This may be used to signal a filter type applied at the block edge. This index is signaled only when the recon_smoothing_flag is 1. When the recon_smoothing_flag is not signaled or is 0, the recon_smoothing_filterType_idx is inferred to be 0.

According to an embodiment of the present disclosure, when smoothing or filtering is applied to a block edge, and two blocks exist with a block boundary therebetween, a type of a smoothing filter may be determined differently or identically in consideration of the characteristics of the texture inside the two blocks or intra modes. In this regard, all types of filters may be used.

According to an embodiment of the present disclosure, when smoothing or filtering is applied to a block edge, a type of a filter to be used in a neighboring block, a neighboring coding unit, a neighboring largest coding unit, a neighboring slice, or the same picture may be shared and applied.

According to an embodiment of the present disclosure, when smoothing or filtering is applied to a block edge, discontinuity that may occur at a boundary between blocks may be first removed by first applying in-loop filter technologies of the related art to the reconstructed region.

Any types of filters may be used for smoothing or filtering. Image filtering or smoothing is an operation that defines a square matrix in the form of a kernel, moves the kernel over an image, performs an operation on a region within the image overlapping with the kernel, and then generates a new image by replacing pixels in the region within the image where an operation was performed with a resulting value. Examples of this filtering method include Average Filtering, Gaussian Filtering, Median Filtering, Bilateral Filtering, low-pass filtering, high-pass filtering, convolution filtering, linear filtering, non-linear filtering, strong filtering, etc.

In addition, to further emphasize an edge region of the block, a strong filter may be applied before a smoothing filter is applied. A strong filter may be used to amplify the original noise or edge components. By applying a smoothing filter after applying a strong filter, unnecessary information may be filtered by further clarifying an important edge component and then removing unnecessary noise or block partition boundaries.

Hereinafter, a method of obtaining a histogram value by first applying a strong filter to a template region of decoder-side intra mode derivation (DIMD), emphasizing an edge component and then partially obtaining a gradient will be described below with reference to FIG. 23.

FIG. 23 is a diagram for describing a DIMD method according to an embodiment of the present disclosure.

Referring to FIG. 23, first, a strong filter is applied to pixels in a template region 2310 of a current block 2300. The strong filter is a filter 2320 with a 3×3 size that is applied to a target pixel 2325. Filter coefficients of the strong filter 2320 is shown in Equation 4 below. Among the filter coefficients, a filter coefficient of 10 corresponding to a location of row 2 and column 2 is applied to the target pixel 2325, and a filter coefficient of −1 is applied to neighboring pixels.

$$F = [ \begin{matrix}- 1 & - 1 & - 1 \\ - 1 & 10 & - 1 \\ - 1 & - 1 & - 1\end{matrix} ] \qquad [ Equation 4 ]$$

The strong filter 2320 is applied to the entire template region 2310 so that a template region 2310 in which an edge component is emphasized is obtained.

Unlike the DIMD of FIG. 20, a gradient histogram is obtained by using gradient operators of 3×2 and 2×3 in left and top templates of the template region 2310 where the edge component is emphasized.

The gradient operator of 3×2 used for the left template, that is, a filter, is shown in Equation 5 below. M_{y} is a filter for obtaining a horizontal gradient, and Mₓ is a filter for obtaining a vertical gradient.

$${M}_{y} = [ \begin{matrix}1 & - 1 \\ 2 & - 2 \\ 1 & - 1\end{matrix} ] , {M}_{x} = [ \begin{matrix}- 1 & - 3 \\ 0 & 0 \\ 1 & 3\end{matrix} ] \qquad [ Equation 5 ]$$

The gradient operator of 2×3 used in the upper template, that is, a filter, is shown in Equation 6 below. M_{y} is a filter for obtaining a horizontal gradient, and Mₓ is a filter for obtaining a vertical gradient.

$${M}_{y} = [ \begin{matrix}1 & 0 & - 1 \\ 3 & 0 & - 3\end{matrix} ] , {M}_{x} = [ \begin{matrix}- 1 & - 2 & - 1 \\ 1 & 2 & 1\end{matrix} ] , \qquad [ Equation 6 ]$$

A location corresponding to a target pixel in the gradient operator of 3×2 used in the left template is row 2 and column 2. In addition, a location corresponding to a target pixel in the gradient operator of 2×3 used in the upper template is row 2 and column 2.

For example, as shown in FIG. 23, a 2×3 gradient operator 2330 is applied to a target pixel 2335 in the upper template in the template region 2310.

A prediction mode is derived based on the gradient histogram obtained with respect to the template region 2310, and the current block 2300 is predicted based on the derived prediction mode.

In the case of using a reconstructed region in intra prediction, apart from a method of performing filtering on a boundary of a block, in-loop filtering is performed on the reconstructed image in units of frames.

In-loop filtering technology may include not only a deblocking filter for removing blocking artifacts but also a sample adaptive offset (SAO) and an adaptive loop filter (ALF) to compensate for information loss caused by loss compression such as quantization. By using these filters, compression efficiency as well as subjective image quality may be improved. Deblocking filtering may prevent error propagation between frames by reducing errors occurring between block boundaries in a reconstructed image, thereby improving both subjective and objective image quality. In particular, deblocking filtering technology improves subjective image quality by effectively removing distortion of a block boundary caused by prediction and quantization. In addition, deblocking filtering technology performs adaptive filtering that applies discriminative filtering based on a degree of distortion occurring at the block boundary. In other words, different filtering is performed on a region where distortion is likely to occur at the boundary of the block and a region where distortion is unlikely to occur, thereby minimizing new distortions that may be caused by unnecessary or excessive filtering. However, this adaptive deblocking filtering technology requires a significant amount of operations to measure information about distortion and apply different filters.

These in-loop filter technologies are applied at once in units of frames after all predictions are performed. In addition, filtering in units of transformation may be applied to in-loop filter technologies.

A general deblocking filtering method and a deblocking filtering method when filtering is performed on a reconstructed region or a template region in intra prediction will be described below with reference to FIGS. 24 to 26.

FIG. 24 illustrates an example of samples located at a boundary between two blocks to which deblocking filtering is applied.

Referring to FIG. 24, a boundary 2420 of blocks is located between a block P 2400 and a block Q 2410. Specifically, samples p_{0,0}, p_{0,1}, p_{0,2}, and p_{0,3} are the closest to the boundary 2420, samples p_{1,0}, p_{1,1}, p_{1,2}, and p_{1,3} are one pixel away from the boundary 2420, samples p_{2,0}, p_{2,1}, p_{2,2}, and p_{2,3} are two pixels away from the boundary 2420, and samples p_{3,0}, p_{3,1}, p_{3,2}, and p_{3,3} are three pixels away from the boundary 2420 in the block P 2400 with respect to the 2420 of blocks. Similarly, samples q_{0,0}, q_{0,1}, q_{0,2}, and q_{0,3} are the closest to the boundary 2420, samples q_{1,0}, q_{1,1}, q_{1,2}, and q_{1,3} are one pixel away from the boundary 2420, samples q_{2,0}, q_{2,1}, q_{2,2}, and q_{2,3} are two pixels away from the boundary 2420, and samples q_{3,0}, q_{3,1}, q_{3,2}, and q_{3,3} are three pixels away from the boundary 2420 in the block Q 2410 with respect to the 2420 of blocks.

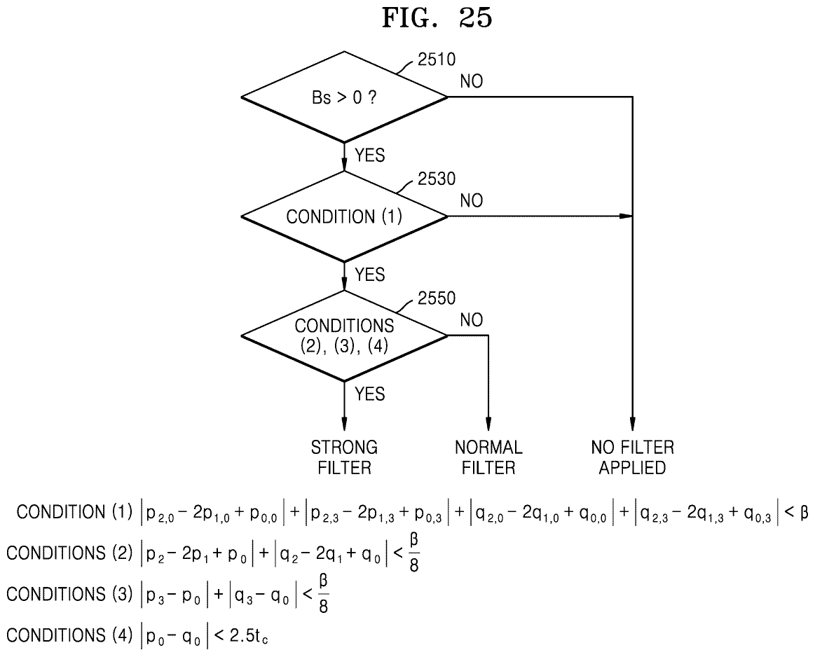

FIG. 25 is a diagram for describing a method of determining a type of a filter for deblocking filtering.

Referring to FIG. 25, in operation 2510, a filtering parameter Bs indicating the intensity of a block boundary is first determined. A value of the filtering parameter Bs is determined as one of 0, 1, and 2. Specifically, when at least one of two adjacent blocks is an intra-predicted block, the value of the filtering parameter Bs is determined to be 2. When at least one of the two blocks has a non-zero coded residual coefficient and a boundary of the blocks is a transformation boundary, the value of the filtering parameter Bs is determined to be 1. When an absolute difference between the corresponding spatial motion vector components of the two blocks is 1 or more in integer pixel units, the value of the filtering parameter Bs is determined to be 1. When motion compensation prediction for the two blocks refers to different reference pictures or the number of motion vectors for the two blocks is different, the value of the filtering parameter Bs is determined to be 1. In all other cases except for the conditions, the value of the filtering parameter Bs is determined to be 0.

Referring back to FIG. 25, when the value of the filtering parameter Bs is 0 in operation 2510, it is determined that filtering is not applied, and when the value of the filtering parameter Bs is greater than 0, condition (1) is determined in operation 2530. β and tc mentioned in conditions (1) to (4) refer to threshold values applied when the intensity of a filter is determined or filtering is performed. β and tc are determined as predefined values based on quantization parameters.

When condition (1) is not satisfied in operation 2530, filtering is not applied.

When condition (1) is satisfied in operation 2530, conditions (2), (3), and (4) are determined in operation 2550.

When conditions (2), (3), and (4) are all satisfied in operation 2550, the type of a deblocking filter is determined as a strong filter with a high filtering intensity. When any one of conditions (2), (3), and (4) is not satisfied, the type of the deblocking filter is determined as a normal filter.

For the normal filter, one of filters [3, 7, 9, −3]>>4 and [8 19 −19 −3]>>5 is used, and for the strong filter, one of filters [1 2 2 2 1]>>3, [1 1 1 1]>>2, and [2 3 1 1 1]>>3 is used. However, the disclosure is not limited thereto.

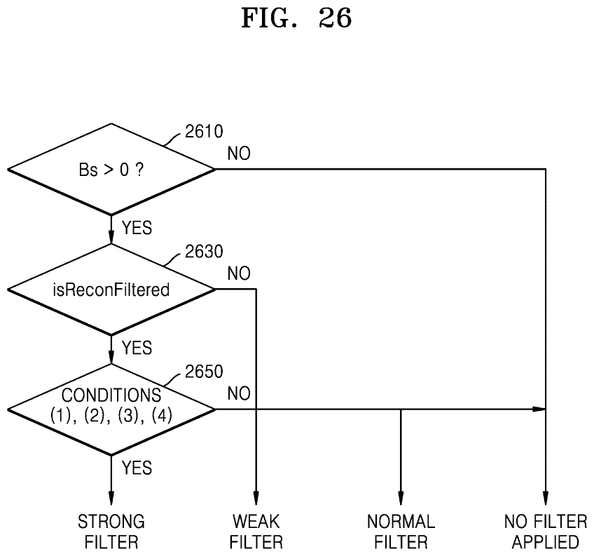

FIG. 26 is a diagram for describing deblocking filtering according to an embodiment of the present disclosure.

Referring to FIG. 26, when Bs is 0 in operation 2610, it is determined that filtering is not applied. When Bs is greater than 0 in operation 2610, a value of isReconFiltered indicating whether filtering has been applied to a block boundary in an intra prediction process is determined in operation 2630.

When the value of isReconFiltered is 0 in operation 2630, that is, when filtering is not applied to the block boundary in the intra prediction process, a type of a deblocking filter is determined as a weak filter.

When the value of isReconFiltered is 1 in operation 2630, that is, when filtering is applied to the block boundary in the intra prediction process, conditions (1), (2), (3), and (4) are determined in operation 2650. Conditions (1), (2), (3), (4) mean conditions (1), (2), (3), (4) shown in FIG. 25.

When conditions (1), (2), (3), and (4) are all satisfied in operation 2650, the type of filtering is determined as a strong filter.

When any one of the conditions (1), (2), (3), and (4) is not satisfied in operation 2650, in some cases, the type of filtering may be determined as a weak filter or a normal filter, or it may be determined that filtering is not applied.

The deblocking filtering method of FIG. 26 may apply a strong filter to a region to which smoothing or filtering has already been applied when deblocking filtering is applied in units of actual frames, based on a value indicating whether smoothing or filtering is applied to a boundary of blocks when intra prediction is performed, and remove unnecessary additional smoothing or filtering by applying a weak filter because there is no significant difference even though there is the boundary of blocks in a region to which smoothing or filtering is not applied. Filtering may be performed by adjusting the existing normal filter instead of the weak filter.

In addition, Bs may be adjusted or implicitly the type of a filter may be determined by additionally considering isReconFiltered for each block.

For the weak filter, one of filters [1 2 2 2 1]>>3, [1 3 8 3 1]>>4, and [0 0.5 1 0.5 0]>>1 is used. However, the disclosure is not limited thereto.

Image decoding methods, image decoding apparatuses, image encoding methods, and image encoding apparatuses using an intra TMP to which boundary filtering is applied according to an embodiment of the present disclosure are described in detail with reference to FIGS. 27 to 30.

FIG. 27 is a diagram for describing an image decoding method according to an embodiment of the present disclosure.

Referring to FIG. 27, in operation S2710, an image decoding apparatus 2800 may perform boundary filtering on a template region located around a current block.

According to an embodiment of the present disclosure, the template region may be an L-shaped region including at least one left reference sample located on the left of the current block, at least one top left reference sample located on the top left of the current block, and at least one top reference sample located on the top of the current block.

In operation S2720, the image decoding apparatus 2800 may identify a first search template region and a second search template region which correspond to the template region in a current picture including the current block.

According to an embodiment of the present disclosure, the search region may include a reconstructed region in the current picture.

In operation S2730, the image decoding apparatus 2800 may perform boundary filtering on the first search template region and the second search template region.

In operation S2740, the image decoding apparatus 2800 may determine a search template region that is most similar to the filtered template region among the filtered first search template region and the filtered second search template region.

In operation S2750, the image decoding apparatus 2800 may determine a matching block corresponding to the current block based on the most similar search template region.

In operation S2760, the image decoding apparatus 2800 may perform boundary filtering on the matching block.

According to an embodiment of the present disclosure, an intensity of boundary filtering may be determined based on a size of the current block.

According to an embodiment of the present disclosure, the intensity of boundary filtering may be determined based on intra prediction modes of blocks in the search region.

According to an embodiment of the present disclosure, the intensity of boundary filtering may be determined based on the number of blocks in the search region.

According to an embodiment of the present disclosure, whether boundary filtering is performed may be determined based on a flag for indicating whether boundary filtering is performed, which is obtained from a bitstream.

According to an embodiment of the present disclosure, a type of boundary filtering may be determined based on an index indicating a filter type obtained from the bitstream.

According to an embodiment of the present disclosure, an intensity of boundary filtering on the template region, an intensity of boundary filtering on the first search template region, an intensity of boundary filtering on the second search template region, and an intensity of boundary filtering on the matching block may be independently determined.

In operation S2770, the image decoding apparatus 2800 may predict the current block based on the filtered matching block.

According to an embodiment of the present disclosure, the filtering intensity of deblocking filtering on the current picture may be determined according to whether boundary filtering is performed.

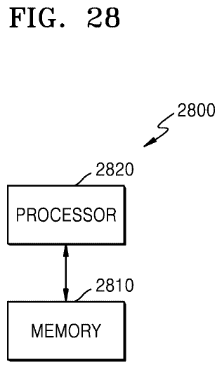

FIG. 28 is a block diagram illustrating an image decoding apparatus according to an embodiment of the present disclosure.

The image decoding apparatus 2800 according to an embodiment may include at least one memory 2810 and at least one processor 2820 connected to the at least one memory 2810. The at least one memory 2810 may include instructions implementing an embodiment of the present disclosure. The at least one processor 2820 may be operably coupled to the at least one memory 2810 and configured to implement an embodiment of the present disclosure by executing the instructions included in the at least one memory 2810. Operations of the image encoding apparatus 2800 according to an embodiment of the present disclosure may operate as individual processors or may operate by the control of a central processor.

The above-described image decoding method of FIG. 27 may be implemented by the image decoding apparatus 2800 according to an embodiment of the present disclosure.

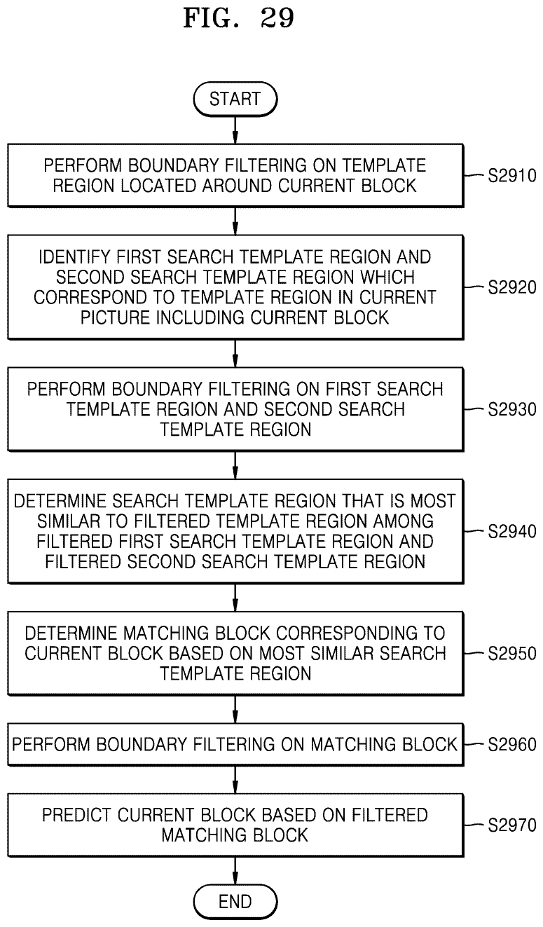

FIG. 29 is a diagram for describing an image encoding method according to an embodiment of the present disclosure.

Referring to FIG. 29, in operation S2910, an image encoding apparatus 3000 may perform boundary filtering on a template region located around a current block.

According to an embodiment of the present disclosure, the template region may be an L-shaped region including at least one left reference sample located on the left of the current block, at least one top left reference sample located on the top left of the current block, and at least one top reference sample located on the top of the current block.

In operation S2920, the image encoding apparatus 3000 may identify a first search template region and a second search template region which correspond to the template region in a current picture including the current block.

According to an embodiment of the present disclosure, the search region may include an encoded region in the current picture.

In operation S2930, the image encoding apparatus 3000 may perform boundary filtering on the first search template region and the second search template region.

In operation S2940, the image encoding apparatus 3000 may determine a search template region that is most similar to the filtered template region among the filtered first search template region and the filtered second search template region.

In operation S2950, the image encoding apparatus 3000 may determine a matching block corresponding to the current block based on the most similar search template region.

In operation S2960, the image encoding apparatus 3000 may perform boundary filtering on the matching block.

According to an embodiment of the present disclosure, an intensity of boundary filtering may be determined based on a size of the current block.

According to an embodiment of the present disclosure, the intensity of boundary filtering may be determined based on intra prediction modes of blocks in the search region.

According to an embodiment of the present disclosure, the intensity of boundary filtering may be determined based on the number of blocks in the search region.

According to an embodiment of the present disclosure, whether boundary filtering is performed may be determined based on a generated flag for indicating whether boundary filtering is performed. The flag for indicating whether boundary filtering is performed may be signaled according to RDO calculation.

According to an embodiment of the present disclosure, a type of boundary filtering may be determined based on a generated index indicating filter type. The index indicating the filter type may be signaled according to RDO calculation.

According to an embodiment of the present disclosure, an intensity of boundary filtering on the template region, an intensity of boundary filtering on the first search template region, an intensity of boundary filtering on the second search template region, and an intensity of boundary filtering on the matching block may be independently determined.

In operation S2970, the image encoding apparatus 3000 may predict the current block based on the filtered matching block.

According to an embodiment of the present disclosure, the filtering intensity of the deblocking filtering on the current picture may be determined according to whether boundary filtering is performed.

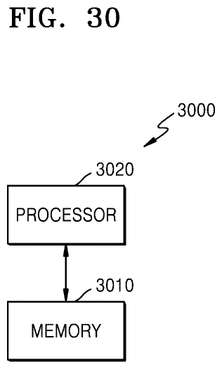

FIG. 30 is a block diagram illustrating an image encoding apparatus according to an embodiment of the present disclosure.

The image encoding apparatus 3000 according to an embodiment may include the at least one memory 3010 and the at least one processor 3020 connected to the at least one memory 3010. The at least one memory 3010 may include instructions implementing an embodiment of the present disclosure. The at least one processor 3020 may be operably coupled to the at least one memory 3010 and configured to implement an embodiment of the present disclosure by executing the instructions included in the at least one memory 3010. Operations of the image encoding apparatus 3000 according to an embodiment of the present disclosure may operate as individual processors or may operate by the control of a central processor.

The above-described image encoding method of FIG. 29 may be implemented by the image encoding apparatus 3000 according to an embodiment of the present disclosure.

According to an embodiment of the present disclosure, an image decoding method may include performing boundary filtering on a template region located around a current block, identifying a first search template region and a second search template region which correspond to the template region in a search region in a current picture including the current block, performing boundary filtering on the first search template region and the second search template region, determining a search template region that is most similar to the filtered template region among the filtered first search template region and the filtered second search template region, determining a matching block corresponding to the current block based on the most similar search template region, performing boundary filtering on the matching block, and predicting the current block based on the filtered matching block.

In the image decoding method according to an embodiment of the present disclosure, overhead of information transmission may be reduced by performing prediction without transmitting information about an intra prediction mode, and prediction efficiency may be improved by removing discontinuity at a boundary between blocks in a region used for intra prediction.

According to an embodiment of the present disclosure, the template region may be an L-shaped region including at least one left reference sample located on the left of the current block, at least one top left reference sample located on the left of the current block, and at least one top reference sample located on the top of the current block.

In the image decoding method according to an embodiment of the present disclosure, intra prediction may be performed without transmitting information about the intra prediction mode by using neighboring reference samples close to the current block as a template region.

According to an embodiment of the present disclosure, the search region may include a reconstructed region in the current picture.

In the image decoding method according to an embodiment of the present disclosure, the efficiency of intra prediction may be improved without transmitting information about the intra prediction mode by searching for a region that is most similar to the template region in the reconstructed region in the current picture including the current block.

According to an embodiment of the present disclosure, an intensity of boundary filtering may be determined based on a size of the current block.

According to an embodiment of the present disclosure, an intensity of boundary filtering may be determined based on intra prediction modes of blocks in the search region.

According to an embodiment of the present disclosure, an intensity of boundary filtering may be determined based on the number of blocks in the search region.

In the image decoding method according to an embodiment of the present disclosure, discontinuity at the boundary between blocks may be effectively removed and efficiency of intra prediction may be improved by determining the intensity of filtering according to the characteristics of blocks in consideration of the size of the current block, the intra prediction modes of blocks in the search region, or the number of blocks in the search region.

According to an embodiment of the present disclosure, whether boundary filtering is performed may be determined based on a flag for indicating whether boundary filtering is performed, which is obtained from a bitstream.

In the image decoding method according to an embodiment of the present disclosure, discontinuity at the boundary of the blocks may be removed by performing filtering by using a flag for indicating whether boundary filtering is performed, and overhead may be reduced by transmitting a flag as to whether boundary filtering of a small bit is performed without transmitting information about an intra prediction mode.

According to an embodiment of the present disclosure, a type of boundary filtering may be determined based on an index indicating a filter type obtained from the bitstream.

In the image decoding method according to an embodiment of the present disclosure, the filter type is determined based on the index, and thus, discontinuity is effectively removed by applying an appropriate filter, and overhead may be reduced by transmitting an index indicating a filter type of a small bit without transmitting information about the intra prediction mode.

According to an embodiment of the present disclosure, an intensity of boundary filtering on the template region, an intensity of boundary filtering on the first search template region, an intensity of boundary filtering on the second search template region, and an intensity of boundary filtering on the matching block may be independently determined.

In the image decoding method according to an embodiment of the present disclosure, the intensity of filtering is independently determined according to the characteristics of each region to which boundary filtering is applied, and thus, discontinuity of each region may be effectively removed.

According to an embodiment of the present disclosure, a filtering intensity of deblocking filtering on the current picture may be determined according to whether the boundary filtering is performed.

In the image decoding method according to an embodiment of the present disclosure, deblocking filtering may be performed more efficiently by determining the filtering intensity of deblocking filtering in consideration of the characteristics at a boundary of blocks (i.e., whether discontinuity exists discontinuity at the boundary of blocks) according to whether boundary filtering is performed.

According to an embodiment, an image decoding apparatus may include memory storing one or more instructions and at least one processor configured to operate according to the one or more instructions. The at least one processor may perform boundary filtering on a template region located around a current block. The at least one processor may identify a first search template region and a second search template region which correspond to the template region in a search region in a current picture including the current block. The at least one processor may perform boundary filtering on the first search template region and the second search template region. The at least one processor may determine a search template region that is most similar to the filtered template region among the filtered first search template region and the filtered second search template region. The at least one processor may determine a matching block corresponding to the current block based on the most similar search template region. The at least one processor may perform boundary filtering on the matching block. The at least one processor may predict the current block based on the filtered matching block.

The image decoding apparatus according to an embodiment of the present disclosure may reduce an overhead of information transmission by performing prediction without transmitting information about an intra prediction mode, and improve prediction efficiency by removing discontinuity at a boundary between blocks in a region used for intra prediction.

According to an embodiment of the present disclosure, the template region may be an L-shaped region including at least one left reference sample located on the left of the current block, at least one top left reference sample located on the left of the current block, and at least one top reference sample located on the top of the current block.

In the image decoding apparatus according to an embodiment of the present disclosure, intra prediction may be performed without transmitting information about the intra prediction mode by using neighboring reference samples close to the current block as a template region.

According to an embodiment of the present disclosure, the search region may include a reconstructed region in the current picture.

The image decoding apparatus according to an embodiment of the present disclosure may improve the efficiency of intra prediction without transmitting information about the intra prediction mode by searching for a region that is most similar to the template region in the reconstructed region in the current picture including the current block.

According to an embodiment of the present disclosure, an intensity of boundary filtering may be determined based on a size of the current block.

According to an embodiment of the present disclosure, an intensity of boundary filtering may be determined based on intra prediction modes of blocks in the search region.

According to an embodiment of the present disclosure, an intensity of boundary filtering may be determined based on the number of blocks in the search region.

The image decoding apparatus according to an embodiment of the present disclosure may effectively remove discontinuity at the boundary between blocks and improve efficiency of intra prediction by determining the intensity of filtering according to the characteristics of blocks in consideration of the size of the current block, the intra prediction modes of blocks in the search region, or the number of blocks in the search region.

According to an embodiment of the present disclosure, whether boundary filtering is performed may be determined based on a flag for indicating whether boundary filtering is performed, which is obtained from a bitstream.

The image decoding apparatus according to an embodiment of the present disclosure may remove discontinuity at the boundary of blocks by performing filtering by using a flag for indicating whether boundary filtering is performed, and reduce overhead by transmitting a flag as to whether boundary filtering of a small bit is performed without transmitting information about an intra prediction mode.

According to an embodiment of the present disclosure, a type of boundary filtering may be determined based on an index indicating a filter type obtained from the bitstream.

The image decoding apparatus according to an embodiment of the present disclosure may effectively remove discontinuity by determining the filter type based on the index and applying an appropriate filter, and reduce overhead by transmitting an index indicating a filter type of a small bit without transmitting information about the intra prediction mode.

According to an embodiment of the present disclosure, an intensity of boundary filtering on the template region, an intensity of boundary filtering on the first search template region, an intensity of boundary filtering on the second search template region, and an intensity of boundary filtering on the matching block may be independently determined.

The image decoding apparatus according to an embodiment of the present disclosure may independently determine the intensity of the filtering according to the characteristics of each region to which boundary filtering is applied, thereby effectively removing discontinuity of each region.

According to an embodiment of the present disclosure, a filtering intensity of deblocking filtering on the current picture may be determined according to whether the boundary filtering is performed.

The image decoding apparatus according to an embodiment of the present disclosure perform more efficiently deblocking filtering by determining the filtering intensity of deblocking filtering in consideration of the characteristics at a boundary of blocks (i.e., whether discontinuity exists discontinuity at the boundary of blocks) according to whether boundary filtering is performed.

According to an embodiment of the present disclosure, an image encoding method may include performing boundary filtering on a template region located around a current block, identifying a first search template region and a second search template region which correspond to the template region in a search region in a current picture including the current block, performing boundary filtering on the first search template region and the second search template region, determining a search template region that is most similar to the filtered template region among the filtered first search template region and the filtered second search template region, determining a matching block corresponding to the current block based on the most similar search template region, performing boundary filtering on the matching block, and predicting the current block based on the filtered matching block.

In the image encoding method according to an embodiment of the present disclosure, overhead of information transmission may be reduced by performing prediction without transmitting information about an intra prediction mode, and prediction efficiency may be improved by removing discontinuity at a boundary between blocks in a region used for intra prediction.

According to an embodiment of the present disclosure, the template region may be an L-shaped region including at least one left reference sample located on the left of the current block, at least one top left reference sample located on the left of the current block, and at least one top reference sample located on the top of the current block.

In the image encoding method according to an embodiment of the present disclosure, intra prediction may be performed without transmitting information about the intra prediction mode by using neighboring reference samples close to the current block as a template region.

According to an embodiment of the present disclosure, the search region may include an encoded region in the current picture.

In the image encoding method according to an embodiment of the present disclosure, the efficiency of intra prediction may be improved without transmitting information about the intra prediction mode by searching for a region that is most similar to the template region in the encoded region in the current picture including the current block.

According to an embodiment of the present disclosure, an intensity of boundary filtering may be determined based on a size of the current block.

According to an embodiment of the present disclosure, an intensity of boundary filtering may be determined based on intra prediction modes of blocks in the search region.

According to an embodiment of the present disclosure, an intensity of boundary filtering may be determined based on the number of blocks in the search region.

In the image encoding method according to an embodiment of the present disclosure, discontinuity at the boundary between blocks may be effectively removed and efficiency of intra prediction may be improved by determining the intensity of filtering according to the characteristics of blocks in consideration of the size of the current block, the intra prediction modes of blocks in the search region, or the number of blocks in the search region.

According to an embodiment of the present disclosure, a flag for indicating whether boundary filtering is performed may be generated, and whether boundary filtering is performed may be determined based on the generated flag as whether boundary filtering is performed.

In the image encoding method according to an embodiment of the present disclosure, the discontinuity at the boundary of the blocks may be removed by performing filtering by using a flag for indicating whether boundary filtering is performed, and overhead may be reduced by transmitting a flag as to whether boundary filtering of a small bit is performed without transmitting information about an intra prediction mode.

According to an embodiment of the present disclosure, an index indicating a filter type may be generated, and a type of boundary filtering may be determined based on the generated index.

In the image encoding method according to an embodiment of the present disclosure, the filter type is determined based on the index, and thus, discontinuity is effectively removed by applying an appropriate filter, and overhead may be reduced by transmitting an index indicating a filter type of a small bit without transmitting information about the intra prediction mode.

According to an embodiment of the present disclosure, an intensity of boundary filtering on the template region, an intensity of boundary filtering on the first search template region, an intensity of boundary filtering on the second search template region, and an intensity of boundary filtering on the matching block may be independently determined.

In the image encoding method according to an embodiment of the present disclosure, the intensity of filtering is independently determined according to the characteristics of each region to which boundary filtering is applied, and thus, discontinuity of each region may be effectively removed.

According to an embodiment of the present disclosure, a filtering intensity of deblocking filtering on the current picture may be determined according to whether the boundary filtering is performed.

In the image encoding method according to an embodiment of the present disclosure, deblocking filtering may be performed more efficiently by determining the filtering intensity of deblocking filtering in consideration of the characteristics at a boundary of blocks (i.e., whether discontinuity exists at the boundary of blocks) according to whether boundary filtering is performed.

According to an embodiment, an image encoding apparatus may include memory storing one or more instructions and at least one processor configured to operate according to the one or more instructions. The at least one processor may perform boundary filtering on a template region located around a current block. The at least one processor may identify a first search template region and a second search template region which correspond to the template region in a search region in a current picture including the current block. The at least one processor may perform boundary filtering on the first search template region and the second search template region. The at least one processor may determine a search template region that is most similar to the filtered template region among the filtered first search template region and the filtered second search template region. The at least one processor may determine a matching block corresponding to the current block based on the most similar search template region. The at least one processor may perform boundary filtering on the matching block. The at least one processor may predict the current block based on the filtered matching block.

The image encoding apparatus according to an embodiment of the present disclosure may reduce overhead of information transmission by performing prediction without transmitting information about an intra prediction mode, and improve prediction efficiency by removing discontinuity at a boundary between blocks in a region used for intra prediction.

According to an embodiment of the present disclosure, the template region may be an L-shaped region including at least one left reference sample located on the left of the current block, at least one top left reference sample located on the left of the current block, and at least one top reference sample located on the top of the current block.

The image decoding method according to an embodiment of the present disclosure may perform intra prediction without transmitting information about the intra prediction mode by using neighboring reference samples close to the current block as a template region.

According to an embodiment of the present disclosure, the search region may include an encoded region in the current picture.

The image encoding apparatus according to an embodiment of the present disclosure may improve the efficiency of intra prediction without transmitting information about the intra prediction mode by searching for a region that is most similar to the template region in the encoded region in the current picture including the current block.

According to an embodiment of the present disclosure, an intensity of boundary filtering may be determined based on a size of the current block.

According to an embodiment of the present disclosure, an intensity of boundary filtering may be determined based on intra prediction modes of blocks in the search region.

According to an embodiment of the present disclosure, an intensity of boundary filtering may be determined based on the number of blocks in the search region.

The image encoding apparatus according to an embodiment of the present disclosure may effectively remove discontinuity at the boundary between blocks and improve efficiency of intra prediction by determining the intensity of filtering according to the characteristics of blocks in consideration of the size of the current block, the intra prediction modes of blocks in the search region, or the number of blocks in the search region.

According to an embodiment of the present disclosure, a flag for indicating whether boundary filtering is performed may be generated, and whether boundary filtering is performed may be determined based on the generated flag as whether boundary filtering is performed.

The image encoding apparatus according to an embodiment of the present disclosure may remove discontinuity at the boundary of blocks by performing filtering by using a flag for indicating whether boundary filtering is performed, and reduce overhead by transmitting a flag as to whether boundary filtering of a small bit is performed without transmitting information about an intra prediction mode.

According to an embodiment of the present disclosure, an index indicating a filter type may be generated, and a type of boundary filtering may be determined based on the generated index.

The image encoding apparatus according to an embodiment of the present disclosure may effectively remove discontinuity by determining the filter type based on the index, and applying an appropriate filter, and reduce overhead by transmitting an index indicating a filter type of a small bit without transmitting information about the intra prediction mode.

According to an embodiment of the present disclosure, an intensity of boundary filtering on the template region, an intensity of boundary filtering on the first search template region, an intensity of boundary filtering on the second search template region, and an intensity of boundary filtering on the matching block may be independently determined.

The image encoding apparatus according to an embodiment of the present disclosure may independently determine the intensity of the filtering according to the characteristics of each region to which boundary filtering is applied, thereby effectively removing discontinuity of each region.

According to an embodiment of the present disclosure, a filtering intensity of deblocking filtering on the current picture may be determined according to whether the boundary filtering is performed.

The image encoding apparatus according to an embodiment of the present disclosure may perform more efficiently deblocking filtering by determining the filtering intensity of deblocking filtering in consideration of the characteristics at a boundary of blocks (i.e., whether discontinuity exists at the boundary of blocks) according to whether boundary filtering is performed.

The machine-readable storage medium may be provided in the shape of a non-transitory storage medium. Here, the ‘non-transitory storage medium’ only denotes a tangible device and does not include a signal (e.g., electromagnetic waves). This term does not distinguish a case where data is stored in the storage medium semi-permanently and a case where the data is stored in the storage medium temporarily. For example, the ‘non-transitory storage medium’ may include a buffer where data is temporarily store.

According to an embodiment, a method according to various embodiments of the disclosure in the specification may be provided by being included in a computer program product. The computer program product, which is a commodity, may be traded between sellers and buyers. The computer program product may be distributed in the shape of machine-readable storage medium (e.g., compact disc read only memory (CD-ROM)), or distributed (e.g., downloaded or uploaded) through an application store or directly and online between two user devices (e.g., smartphones). In the case of online distribution, at least a part of the computer program product (e.g., a downloadable app) may be at least temporarily generated or temporarily stored in a machine-readable storage medium, such as a server of a manufacturer, a server of an application store, or memory of a relay server.

What is claimed is:

1. An image decoding method comprising:
performing boundary filtering on a template region located around a current block;
identifying a first search template region and a second search template region which correspond to the template region in a search region in a current picture, the current picture comprising the current block;
performing boundary filtering on the first search template region and the second search template region;
determining a search template region that is most similar to a filtered template region among the filtered first search template region and the filtered second search template region;
determining a matching block corresponding to the current block based on the search template region;
performing boundary filtering on the matching block; and
predicting the current block based on the filtered matching block.

2. The image decoding method of claim 1, wherein the template region is an L-shaped region including at least one left reference sample located on a left of the current block, at least one top left reference sample located on a left of the current block, and at least one top reference sample located on a top of the current block.

3. The image decoding method of claim 1, wherein the search region includes a reconstructed region in the current picture.

4. The image decoding method of claim 1, wherein an intensity of the boundary filtering is determined based on a size of the current block.

5. The image decoding method of claim 1, wherein an intensity of the boundary filtering is determined based on intra prediction modes of blocks in the search region.

6. The image decoding method of claim 1, wherein an intensity of the boundary filtering is determined based on a number of blocks in the search region.

7. The image decoding method of claim 1, wherein the boundary filtering is performed based on a flag for indicating whether boundary filtering is performed, the flag being obtained from a bitstream.

8. The image decoding method of claim 7, wherein a type of the boundary filtering is determined based on an index indicating a filter type obtained from the bitstream.

9. The image decoding method of claim 1, wherein an intensity of the boundary filtering on the template region, an intensity of the boundary filtering on the first search template region, an intensity of the boundary filtering on the second search template region, and an intensity of the boundary filtering on the matching block are independently determined.

10. The image decoding method of claim 1, wherein a filtering intensity of deblocking filtering on the current picture is determined based on the boundary filtering being performed.

11. An image encoding method comprising:
performing boundary filtering on a template region located around a current block;
identifying a first search template region and a second search template region which correspond to the template region in a search region in a current picture, the current picture comprising the current block;
performing boundary filtering on the first search template region and the second search template region;
determining a search template region that is most similar to the filtered template region among the filtered first search template region and the filtered second search template region;
determining a matching block corresponding to the current block based on the search template region;
performing boundary filtering on the matching block; and
predicting the current block based on the filtered matching block.

12. The image encoding method of claim 11, wherein the template region is an L-shaped region including at least one left reference sample located on a left of the current block, at least one top left reference sample located on a left of the current block, and at least one top reference sample located on top of the current block.

13. The image encoding method of claim 11, wherein the search region includes an encoded region in the current picture.

14. The image encoding method of claim 11, wherein an intensity of the boundary filtering is determined based on a size of the current block.

15. The image encoding method of claim 11, wherein an intensity of the boundary filtering is determined based on intra prediction modes of blocks in the search region.

16. The image decoding method of claim 10, wherein an intensity of the boundary filtering is determined based on a number of blocks in the search region.

17. The image decoding method of claim 10, wherein the boundary filtering is performed based on a flag for indicating whether boundary filtering is performed, the flag being obtained from a bitstream.

18. The image decoding method of claim 17, wherein a type of the boundary filtering is determined based on an index indicating a filter type obtained from the bitstream.

19. The image decoding method of claim 11, wherein an intensity of the boundary filtering on the template region, an intensity of the boundary filtering on the first search template region, an intensity of the boundary filtering on the second search template region, and an intensity of the boundary filtering on the matching block are independently determined.

20. The image decoding method of claim 10, wherein a filtering intensity of deblocking filtering on the current picture is determined based on the boundary filtering being performed.
